(19) United States
(12) Patent Application Publication
(10) Pub. No.: US 2021/0227450 A1
(43) Pub. Date: Jul. 22, 2021

(54) METHOD FOR ACCESSING NETWORK IN WIRELESS COMMUNICATION SYSTEM, AND DEVICE THEREFOR

(71) Applicant: LG ELECTRONICS INC., Seoul (KR)

(72) Inventor: Sungduck CHUN, Seoul (KR)

(73) Assignee: LG ELECTRONICS INC., Seoul (KR)

(21) Appl. No.: 17/251,732

(22) PCT Filed: Mar. 18, 2019
(86) PCT No.: PCT/KR2019/003138

§ 371 Date: Dec. 11, 2020

(30) Foreign Application Priority Data
Jun. 25, 2018 (KR) 10-2018-0073024
Jul. 18, 2018 (KR) 10-2018-0083509

(51) Int. Cl. H04W 48/06; H04W 48/16; H04W 48/20; H04W 28/02

(52) U.S. Cl. CPC H04W 48/06; H04W 28/0289; H04W 48/20; H04W 48/16

(57) ABSTRACT

Disclosed are a method for accessing a network in a wireless communication system, and a device therefor. Specifically, a method for accessing a network by a user equipment (UE) in a wireless communication system may comprise the steps of: receiving, from a base station, information indicating that access for receiving a service from the network can be performed through a second radio access technology (RAT) in a cell on which the UE is camping through a first RAT; displaying, on a screen, an indication that the access for the service can be performed through the second RAT; and when a user selects the access for the service through the second RAT, performing access to the network through the second RAT in the cell in order to receive the service from the network.

### TECHNICAL FIELD

The present invention relates to a wireless communication system, and more particularly to a method of accessing, by a user equipment (UE), a network and a device supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of the present invention is to propose a method of controlling, by a UE, access to a network in a wireless communication system.

Another object of the present invention is to propose a method of controlling access to a network by a UE supporting a plurality of different radio access methods in a wireless communication system.

Another object of the present invention is to propose a method of controlling access to a network by a UE supporting frequency bands each having a different characteristic in a wireless communication system.

Technical problems to be solved by the present invention are not limited by the abovementioned technical problems, and other technical problems which are not mentioned above can be clearly understood from the following description by those skilled in the art to which the present invention pertains.

### Technical Solution

In one aspect of the present invention, there is provided a method of accessing, by a user equipment (UE), a network in a wireless communication system, the method comprising receiving, from a base station, information that a service access from the network via a second radio access technology (RAT) is possible on a cell camping on via a first RAT, informing a user that the service access via the second RAT is possible, and performing an access to the network so that a service is provided from the network via the second RAT on the cell when the service access via the second RAT is selected from the user.

In another aspect of the present invention, there is provided a user equipment (UE) performing an access to a network in a wireless communication system, the UE comprising a transceiver configured to transmit and receive a radio signal, an input unit, an output unit, and a processor configured to control the transceiver and the output unit, wherein the processor is configured to receive, from a base station, information that a service access from the network via a second radio access technology (RAT) is possible on a cell camping on via a first RAT, inform a user that the service access via the second RAT is possible, through the output unit, and perform an access to the network so that a service is provided from the network via the second RAT on the cell when the service access via the second RAT is selected from the user through the input unit.

Preferably, information that an access barring check operation is able to be skipped may be further received upon an attempt to access the network so that the service is provided from the network via the second RAT on the cell.

Preferably, the access barring check operation may not be performed upon an attempt to access the network so that the service is provided from the network via the second RAT on the cell.

Preferably, the method may further comprise waiting until an access barring timer expires if the service access via the second RAT is not selected from the user.

Preferably, the method may further comprise receiving an access control parameter for the first RAT on the cell, and performing an access barring operation using the access control parameter for the first RAT.

Preferably, when an access via the first RAT is barred on the cell based on the access barring operation using the access control parameter for the first RAT, the information may be received.

Preferably, an access control parameter for the second RAT may be further received on the cell.

Preferably, the performing of the access to the network comprises performing an access barring operation using the access control parameter for the second RAT when the service access via the second RAT is selected from the user, and performing an access to the network via the second RAT when the access via the second RAT is not barred on the cell based on the access barring operation.

Preferably, the method may further comprise configuring whether to allow the access to the network via the second RAT for each application based on an input from the user.

### Advantageous Effects

Embodiments of the present invention can efficiently control access to a wireless network by a UE in a congestion situation of radio resources.

Embodiments of the present invention can provide an opportunity of access to a wireless network to a UE by efficiently controlling access to the wireless network by the UE supporting a plurality of different radio access methods even if a congestion situation of radio resources occurs.

Embodiments of the present invention can provide an opportunity of access to a wireless network to a UE by efficiently controlling access to the wireless network by the UE supporting frequency bands each having a different characteristic.

Effects obtainable from the present invention are not limited by the effects mentioned above, and other effects which are not mentioned above can be clearly understood from the following description by those skilled in the art to which the present invention pertains.

### DESCRIPTION OF DRAWINGS

The accompanying drawings, that are included to provide a further understanding of the invention and are incorporated in and constitute a part of this specification, illustrate embodiments of the invention and together with the description serve to explain various principles of the invention.

FIG. 1 schematically illustrates an evolved packet system (EPS) to which the present invention is applicable.

FIG. 2 illustrates a structure of a radio interface protocol between a UE and an E-UTRAN in a wireless communication system to which the present invention is applicable.

FIG. 3 schematically illustrates a structure of a physical channel in a wireless communication system to which the present invention is applicable.

FIG. 4 illustrates a contention based random access procedure in a wireless communication system to which the present invention is applicable.

FIG. 5 illustrates an architecture of a wireless communication system to which the present invention is applicable.

FIG. 6 illustrates an architecture of a wireless communication system to which the present invention is applicable.

FIG. 7 illustrates an architecture of a wireless communication system to which the present invention is applicable.

FIG. 8 illustrates an operation of access control in a wireless communication system to which the present invention is applicable.

FIG. 9 illustrates a method of accessing a network according to an embodiment of the present invention.

FIG. 10 illustrates a method of accessing a network according to an embodiment of the present invention.

FIG. 11 illustrates a screen of a user equipment according to an embodiment of the present invention.

FIG. 12 illustrates a method of accessing a network according to an embodiment of the present invention.

FIG. 13 illustrates a screen of a user equipment according to an embodiment of the present invention.

FIG. 14 illustrates a method of accessing a network according to an embodiment of the present invention.

FIG. 15 illustrates a method of accessing a network according to an embodiment of the present invention.

FIG. 16 illustrates a block configuration diagram of a communication device according to an embodiment of the present invention.

FIG. 17 is a block diagram illustrating a mobile terminal according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a subsystem providing multimedia services based on the IP.
International Mobile Subscriber Identity (IMSI): an internationally unique subscriber identity allocated in a mobile communication network.
Radio Access Network (RAN): a unit including a Node B, a radio network controller (RNC) controlling the Node B, and an eNodeB in the 3GPP network. The RAN is present at UE-end and provides the connection with a core network.
Home Location Register (HLR)/Home Subscriber Server (HSS): a database with subscriber information within the 3GPP network. The HSS can perform functions of configuration storage, identity management, user state storage, and so on.
Public Land Mobile Network (PLMN): a network configured for the purpose of providing mobile communication services to individuals. The PLMN can be configured for each operator.

In what follows, the present invention will be described based on the terms defined above.

Overview of System to which the Present Invention May be Applied

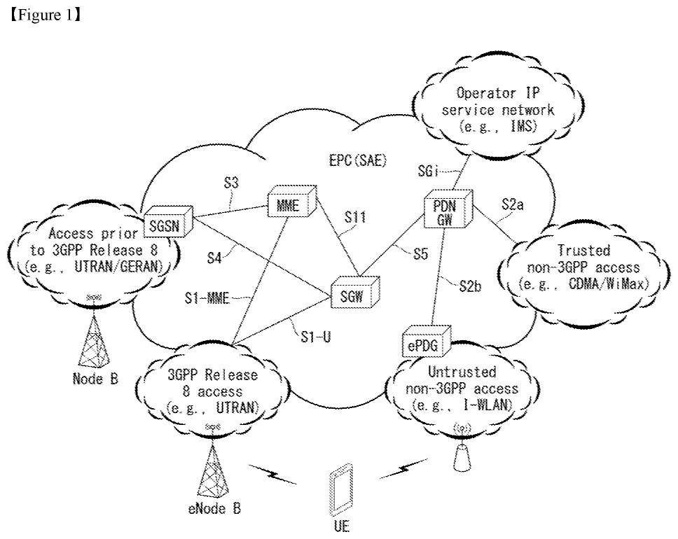

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| Reference | |
|---|---|
| Point | Description |
| S1-MME | Reference point for the control plane protocol between |
| | E-UTRAN and MME |
| S1-U | Reference point between E-UTRAN and Serving GW for the |
| | per bearer user plane tunneling and inter eNodeB path |
| | switching during handover |
| S3 | It enables user and bearer information exchange for inter |
| | 3GPP access network mobility in idle and/or active state. This |
| | reference point may be used intra-PLMN or inter-PLMN (e.g. |
| | in the case of Inter-PLMN HO). |
| S4 | It provides related control and mobility support between GPRS |
| | core and the 3GPP anchor function of Serving GW. In |
| | addition, if direct tunnel is not established, it provides the user |
| | plane tunneling. |
| S5 | It provides user plane tunneling and tunnel management |
| | between Serving GW and PDN GW. It is used for Serving |
| | GW relocation due to UE mobility if the Serving GW needs to |
| | connect to a non-collocated PDN GW for the required PDN |
| | connectivity. |
| S11 | Reference point for the control plane protocol between MME |
| | and SGW |
| SGi | It is the reference point between the PDN GW and the packet |
| | data network. Packet data network may be an operator external |
| | public or private packet data network or an intra-operator |
| | packet data network (e.g., for provision of IMS services). This |
| | reference point corresponds to Gi for 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

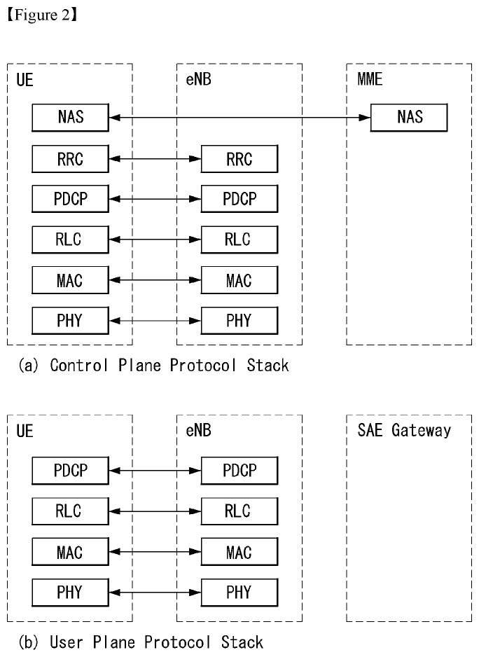

FIG. 2 illustrates a structure of a radio interface protocol between a UE and an E-UTRAN in a wireless communication system to which the present invention is applicable.

FIG. 2(a) illustrates a radio protocol structure for the control plane, and FIG. 2(b) illustrates a radio protocol structure for the user plane.

Referring to FIG. 2, layers of the radio interface protocol between the UE and the E-UTRAN may be divided into a first layer (L1), a second layer (L2), and a third layer (L3) based on three lower layers of an open system interconnection (OSI) standard model that is well-known in the art of communication systems. The radio interface protocol between the UE and the E-UTRAN horizontally consists of a physical layer, a data link layer, and a network layer and is vertically divided into the user plane which is a protocol stack for data information transmission, and the control plane which is a protocol stack for control signaling transmission.

The control plane acts as a path through which control messages used for the UE and the network to manage calls are transmitted. The user plane refers to the path through which the data generated in the application layer, for example, voice data, Internet packet data, and soon are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

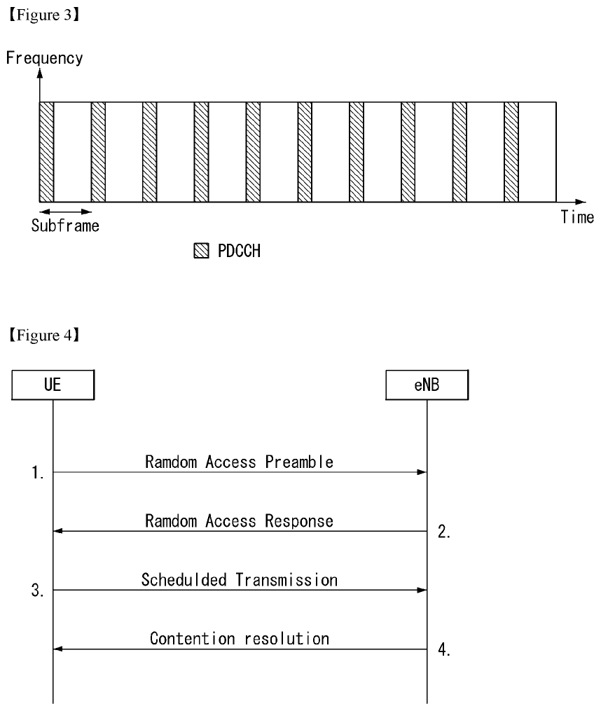

FIG. 3 schematically illustrates a structure of a physical channel in a wireless communication system to which the present invention is applicable.

Referring to FIG. 3, the physical channel transfers signaling and data via radio resources consisting of one or more subcarriers in a frequency domain and one or more symbols in a time domain.

One subframe having a length of 1.0 ms includes a plurality of symbols. A specific symbol(s) of the subframe (e.g., a first symbol of the subframe) may be used for PDCCH. The PDCCH carries information (e.g., resource block, modulation and coding scheme (MCS), etc.) for dynamically allocated resources.

Random Access Procedure

A random access procedure provided by the LTE/LTE-A system will be described below.

The random access procedure is performed when a UE performs an initial access in a RRC idle state because there is no RRC connection with a base station, or when the UE performs a RRC connection re-establishment procedure, etc.

The LTE/LTE-A system provides, in a process for selecting a random access (RACH) preamble, both a contention based random access procedure in which the UE randomly selects and uses one preamble within a specific set and a non-contention based random access procedure in which the UE uses a random access preamble that is allocated to only a specific UE by the base station.

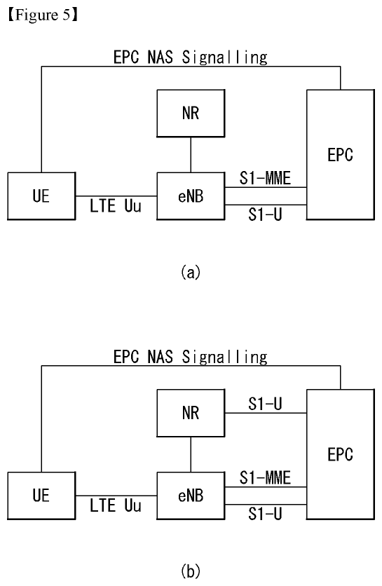

FIG. 4 illustrates a contention based random access procedure in a wireless communication system to which the present invention is applicable.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. On the other hand, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (e.g., SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. On the other hand, in case of receiving the unique identifier (i.e., S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (i.e., S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-dedicated message by using the C-RNTI.

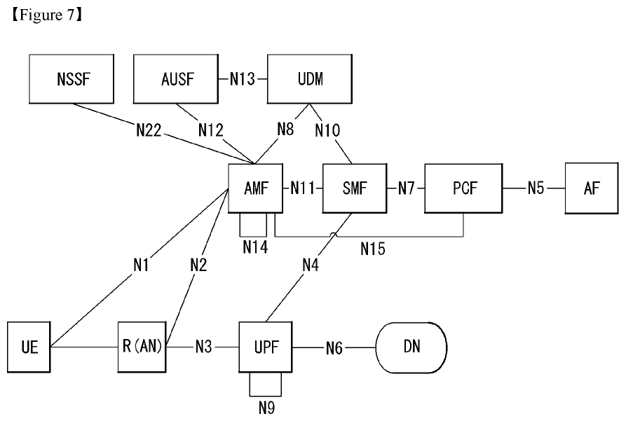

The operation of the non-contention based random access procedure terminates the random access procedure with only the transmission of the message 1 and the message 2, unlike the contention based random access procedure illustrated in FIG. 6. However, the UE is going to be allocated a random access preamble from the eNB before transmitting the random access preamble to the eNB as the message 1, transmits the allocated random access preamble to the eNB as the message 1, and terminates the random access procedure by receiving the random access response from the eNB.

5G (5th Generation) System Architecture

Terms used in the present disclosure may be defined as follows.
Evolved Packet System (EPS): a network system including an Evolved Packet Core (EPC), that is an Internet Protocol (IP) based packet switched core network, and an access network such as LTE and UTRAN. The EPS is a network of an evolved version of a Universal Mobile Telecommunications System (UMTS).
eNodeB: a base station of an EPS network. The eNodeB is installed outdoor, and its coverage has a scale of a macro cell.
International Mobile Subscriber Identity (IMSI): an internationally unique subscriber identity allocated in a mobile communication network.
Public Land Mobile Network (PLMN): a network configured for the purpose of providing mobile communication services to individuals. The PLMN can be configured for each operator.
5G system (5GS): a system composed of a 5G Access Network (AN), a 5G core network and a User Equipment (UE).
5G Access Network (5G-AN) (or AN): an access network composed of a New Generation Radio Access Network (NG-RAN) and/or a non-3GPP Access Network (AN) connected to the 5G core network.
New Generation Radio Access Network (NG-RAN) (or RAN): a Radio Access Network having a common feature of being connected to 5GC and supporting one or more of the following options:

1) Standalone New Radio.

2) New radio that is an anchor supporting E-UTRA extension.

3) Standalone E-UTRA (e.g., eNodeB).

4) Anchor supporting new radio extension
5G Core Network (5GC): a core network connected to a 5G access network.
Network Function (NF): means a processing function adopted in 3GPP within a network or defined in 3GPP. The processing function includes a defined functional behavior and an interface defined in 3GPP.
NF service: a function exposed by the NF via a service-based interface and consumed by other authenticated NF(s).
Network Slice: a logical network that provides specific network capability(s) and network feature(s).
Network Slice instance: a set of NF instance(s) and required resources(s) (e.g., compute, storage, and networking resources) that form a deployed network slice.
Protocol Data Unit (PDU) Connectivity Service: service providing the exchange of PDU(s) between the UE and a data network.
PDU Connectivity Service: service providing the exchange of PDU(s) between the UE and a data network.
PDU Session: association between the UE and the data network that provide the PDU connectivity service. An association type may be Internet Protocol (IP), Ethernet, or unstructured.
Non-Access Stratum (NAS): a functional layer for transceiving signaling and a traffic message between the UE and the core network in EPS and 5GS protocol stack. The NAS mainly functions to support mobility of the UE and support a session management procedure.

A 5G system is an advanced technology from 4G LTE mobile communication technology and supports a new Radio Access Technology (RAT), extended Long Term Evolution (eLTE) as an extended technology of LTE, non-3GPP access (e.g., wireless local area network (WLAN) access), etc. through the evolution of an existing mobile communication network structure or a clean-state structure.

The 5G system architecture is defined to support data connectivity and services so that deployment thereof can use technologies, such as network function virtualization and software-defined networking. The 5G system architecture utilizes service-based interactions are used between control plane (CP) network functions (NFs).

In 3GPP TS 23.501, an architecture using NR (new RAT (radio access technology)) and new generation core (NGC) is specified.

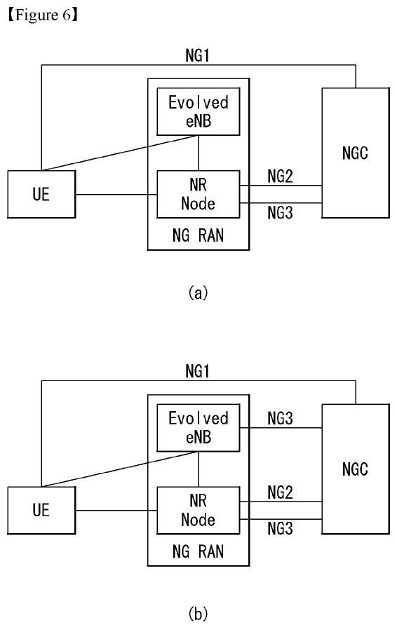

FIG. 5 illustrates an architecture of a wireless communication system to which the present invention is applicable.

FIG. 5 illustrates an example of additionally utilizing NR, i.e., only a radio access technology of 5G in an existing EPS system.

In FIG. 5, an eNB performs a radio resource management using LTE and also additionally manages radio resources using NR. Thus, the eNB can provide various access opportunities by utilizing both LTE and NR.

FIG. 5(a) illustrates an example where a NR cell accesses a core network via the eNB, and FIG. 5(b) illustrates an example where a NR cell directly accesses a core network.

FIG. 6 illustrates an architecture of a wireless communication system to which the present invention is applicable.

FIG. 6 is the opposite situation of FIG. 5 and illustrates an example where LTE radio access is added in a situation in which NG RAN and NGC are utilized.

In FIG. 6, a NR node performs a radio resource management using the NR and also additionally manages radio resources using the LTE. Thus, the NR node can provide various access opportunities by utilizing both LTE and NR.

FIG. 6(a) illustrates an example where a traffic of the eNB accesses a core network via the NR node, and FIG. 6(b) illustrates an example where a traffic of the eNB directly accesses a core network.

FIG. 7 illustrates an architecture of a wireless communication system to which the present invention is applicable.

The 5G system architecture may include various components (i.e., network functions (NFs)), and FIG. 7 illustrates some of the various components.

An access and mobility management function (AMF) supports functions of inter-CN node signaling for mobility between 3GPP access networks, termination of radio access network (RAN) CP interface N2, termination N1 of NAS signaling, registration management (registration area management), idle mode UE reachability, support of network slicing, SMF selection, and the like.

Some or all of the functions of the AMF can be supported in a single instance of one AMF.

A data network (DN) means, for example, operator services, internet access, or 3rd party service, etc. The DN transmits a downlink protocol data unit (PDU) to the UPF or receives the PDU transmitted from the UE from the UPF.

A policy control function (PCF) receives information about packet flow from an application server and provides functions of determining policies such as mobility management and session management.

A session management function (SMF) provides a session management function. If the UE has a plurality of sessions, the sessions can be respectively managed by different SMFs.

Some or all of the functions of the SMF can be supported in a single instance of one SMF.

A unified data management (UDM) stores subscription data of user, policy data, etc.

A user plane function (UPF) transmits the downlink PDU received from the DN to the UE via the (R)AN and transmits the uplink PDU received from the UE to the DN via the (R)AN.

An application function (AF) interacts with 3GPP core network to provide services (e.g., to support functions of an application influence on traffic routing, network capability exposure access, interaction with policy framework for policy control, and the like).

A (radio) access network (R)AN collectively refers to a new radio access network supporting both evolved E-UTRA, that is an evolved version of 4G radio access technology, and anew radio (NR) access technology (e.g., gNB).

The gNB supports functions for radio resource management (i.e., radio bearer control, radio admission control, connection mobility control, and dynamic allocation of resources (i.e., scheduling) to the UE in uplink/downlink)

The UE means a user equipment.

In the 3GPP system, a conceptual link connecting between the NFs in the 5G system is defined as a reference point.

N1 is a reference point between the UE and the AMF, N2 is a reference point between the (R)AN and the AMF, N3 is a reference point between the (R)AN and the UPF, N4 is a reference point between the SMF and the UPF, N6 is a reference point between the UPF and the data network, N9 is a reference point between two core UPFs, N5 is a reference point between the PCF and the AF, N7 is a reference point between the SMF and the PCF, N24 is a reference point between the PCF in the visited network and the PCF in the home network, N8 is a reference point between the UDM and the AMF, N10 is a reference point between the UDM and the SMF, N11 is a reference point between the AMF and the SMF, N12 is a reference point between the AMF and an authentication server function (AUSF), N13 is a reference point between the UDM and the AUSF, N14 is a reference point between two AMFs, N15 is a reference point between the PCF and the AMF in case of non-roaming scenario, reference point between the PCF in the visited network and the AMF in case of roaming scenario, N16 is a reference point between two SMFs (reference point between the SMF in the visited network and the SMF in the home network in case of roaming scenario), N17 is a reference point between AMF and 5G-equipment identity register (EIR), N18 is a reference point between the AMF and an unstructured data storage function (UDSF), N22 is a reference point between the AMF and a network slice selection function (NSSF), N23 is a reference point between the PCF and a network data analytics function (NWDAF), N24 is a reference point between the NSSF and the NWDAF, N27 is a reference point between a network repository function (NRF) in the visited network and the NRF in the home network, N31 is a reference point between NSSF in the visited network and NSSF in the home network, N32 is a reference point between security protection proxy (SEPP) in the visited network and SEPP in the home network, N33 is a reference point between a network exposure function (NEF) and the AF, N40 is a reference point between the SMF and a charging function (CHF), and N50 is a reference point between the AMF and a circuit bearer control function (CBCF).

FIG. 7 illustrates a reference model where the UE accesses to one DN using one PDU session, for convenience of explanation. However, the present invention is not limited thereto.

Access Control Mechanism

Access control is used to control access from a UE depending on a situation of a base station or a core network. For example, when a certain base station can simultaneously support 100 calls, the base station must reject an additionally requested call from the UE in a region of the corresponding base station if 100 calls are already in progress. Otherwise, if the additionally requested call is allowed, the base station exceeds its capacity and thus cannot properly perform the existing 100 calls. In general, the base station does not apply the access control when a usage rate of radio resources, etc. of the corresponding base station is reduced, and adjusts access from the UE as a usage rate of resources of the corresponding base station gradually increases, thereby reducing a new access success rate and preventing problems in a communication system in advance.

There are several types of access control mechanisms, and the most widely used access control barring (ACB) among them will be described herein. The ACB is a method for controlling the allowance of access of the UE according to an access class designated for each UE.

More specifically, the base station designates a probability and a barring timer value for each access class. The probability means how much probability the UE belonging to each access class can actually perform the access. The barring timer indicates when the UE, that cannot perform the access if an access check fails, can perform a next access check.

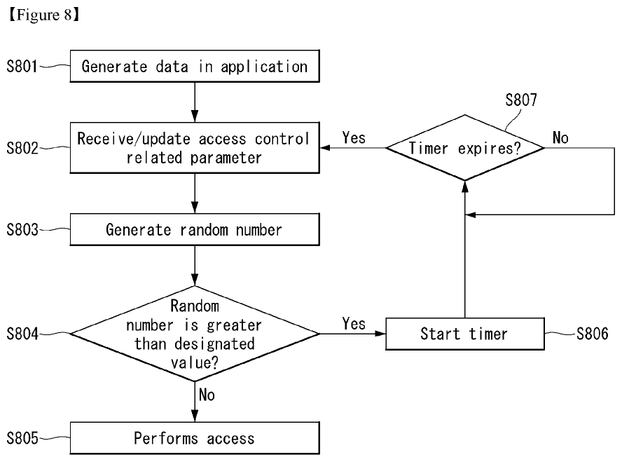

FIG. 8 illustrates an operation of access control in a wireless communication system to which the present invention is applicable.

Referring to FIG. 8, if data to be transmitted is generated in an application in S801, the UE receives an access control related parameter from the base station and updates the parameter in S802.

The UE generates a random number in S803.

The UE checks whether the random number is greater than a designated value in S804.

If the random number is not greater than the designated value as a result of checking in the step S804, the UE performs access to the base station/network for data transfer in S805.

On the other hand, if the random number is greater than the designated value as a result of checking in the step S804, the UE starts a barring timer in S806.

The UE checks whether the barring timer has expired, and if the barring timer has not expired, the UE repeats a process of continuously checking whether the barring timer has expired in S807.

On the other hand, if the barring timer has expired, the UE returns to the step S802 and receives the access control related parameter from the base station and updates the parameter.

Method for Controlling Congestion of Radio Resources

Based on the development of communication technology, the specification of the next generation 5G (5th Generation) system has been completed following the 4G LTE system, and accordingly network equipments and UEs supporting the 5G technology are emerging.

A reason why the transition from the 3G (3rd Generation) communication system to the 4G (4th Generation) communication system has been rapidly made is because the 4G communication system can provide faster and higher-capacity data services than the 3G communication system. Further, a computing device, for example, a smart phone, capable of meeting various requirements of each user has timely emerged in a mobile environment, thereby providing conditions for utilizing the 4G communication system. On the strength of the conditions, the 4G communication system has become more and more popular than the 3G communication system.

The specification of the 5G communication system, that guarantees a faster and higher data transfer rate than the 4G communication system, has been completed, and network equipments and UEs based on the 5G communication system are emerging.

However, from the viewpoint of mobile carriers, there are restrictions on the introduction of the 5G communication system as compared with the 4G communication system. First, since the 5G communication system is not yet in the proliferation stage, the initial introduction cost is higher than the 4G communication system. In addition, the appearance of killer applications, are attractive to the extent that 4G communication service users currently demand the conversion to the 5G communication system, has been delayed.

Hence, the 5G communication system provides options that mobile carriers can use in combination with the 4G communication system in various ways. For example, current 4G mobile carriers can utilize 5G communication system in the following method.
Independent management of 4G communication system and 5G communication system: method for independently introducing a separate 5G communication system to the existing 4G communication system and providing services
Introduction and management of 4G communication system and 5G wireless network: method for introducing not all the 5G communication system but only a 5G wireless network of the 5G communication system and using the 5G wireless network depending on the 4G communication system.
Introduction and management of 4G communication system and 5G core network: method in which mobile carriers do not introduce the 5G wireless system, introduce only a 5G core network, and link a wireless system of the 4G communication to a 4G core network and the 5G core network. Hence, the method uses the 4G as the wireless, uses the 5G as the core network, and uses the same function as the network slicing of the 5G.

The current mobile carriers are interested in the 5G communication system, particularly, the 5G wireless network and new radio access technology (RAT) (NR: New RAT)) that is its radio access technology. It is because the NR is ultra-low latency, ultra-reliable, and ultra-broadband radio access technology.

However, as described above, the 5G communication system seems to have a very high introduction cost as compared to the 4G communication system for a while. Further, even in UE perspective, the UE supporting the 5G communication system is much more expensive than the UE supporting only the 4G communication system, and thus the introduction of the 5G communication system is expected to be delayed from the consumer point of view.

However, since a consumer's usage pattern changes from existing voice-centric to data-centric and from existing text/picture-centric data consumption to video-centric data consumption, demand for data communication is expected to continue to increase. This means that a congestion situation in the existing 4G communication system will continue to deteriorate from the viewpoint of mobile carriers. This means that the use of an access control mechanism (access barring check operation) for controlling the congestion and adjusting the load throughout the communication system is expanded.

However, the existing access control mechanism/operation has the following problems.
An access class barring mechanism used from the 2G (2nd Generation) communication system is defined according to an access class given to each subscriber at the time of subscription, but this has a problem that characteristics of each UE or characteristics of traffic in each situation are not considered.
An ACDC (Application specific Congestion control for Data Communication) mechanism introduced to the 4G communication system is a method for controlling access per an access category in which the mobile carrier categorizes respective applications according to a certain criterion. However, an application, that is not perceived by the mobile carrier or is configured at a low priority by the mobile carrier, has a lot of restrictions on access, and thus the user may badly recognize the quality of communication services.

Accordingly, the present invention proposes an access control method in a situation where various communication systems are present according to the development of the 5G communication system and different sub-networks and different radio access schemes in different communication systems are present according to a strategy of each mobile carrier. In particular, the present invention proposes an access control method capable of preventing a congestion situation that may occur when managing the communication system, rapidly processing the congestion situation, and providing optimal radio services to each UE even in the congestion situation by providing different radio access opportunities depending on characteristics of the UE in the above situation.

More specifically, when a communication system (e.g., 4G communication system) additionally supports another radio access network or another radio access technology (secondary access) besides a basic radio access network or a basic radio access technology by business setting, the communication system informs the UE, that attempts to access the communication system, of information about which access control mechanism the corresponding UE uses or which access control mechanism the corresponding UE can skip/omit.

When the UE itself has to access a communication network, the UE decides which access control mechanism is activated in each cell. The UE uses its conditions to decide which access control mechanism may be skipped for each access control mechanism activated in the cell. After that, the UE examines/checks whether the UE actually attempts to access the access control mechanism the UE has to apply, and attempts to access if the examination/check passes.

Preferably, in the above process, when the communication system informs the UE of whether the access control mechanism can be skipped in the cell, the communication system can additionally inform the UE of information about whether the UE can skip the access control mechanism if a certain condition (hereinafter, skip condition for access barring) is satisfied. The UE skips the corresponding access control mechanism when the skip condition for access barring is satisfied.

Preferably, in the above process, the skip condition for access barring capable of skipping the access control mechanism may include, for example, the radio access technology and/or a supported radio frequency band supported by the communication system.

For example, the following is an example to which an embodiment proposed by the present invention is applied.

1. It is assumed that certain UEs A and B are camping on a cell C based on an E-UTRA radio access scheme managed by eNB N.

In embodiments, eNB N can additionally provide a radio access service via a frequency band FB2 in a NR radio access scheme, and a radio resource used at this time is referred to as cell D. It is also assumed that the cell D supports the NR scheme, but the UE cannot directly search the cell D. For example, the mobile carrier may transmit a system information block (SIB), etc. to the cell D so that the UE cannot camp on the cell D. Thus, since the cell D does not transmit the SIB in the UE perspective, the UE cannot search the cell D in an idle mode. Thus, the UE cannot camp on the corresponding cell.

The UE A simultaneously supports the NR besides the E-UTRA, and also supports the frequency band FB2.

The UE B does not support the NR.

2. There area lot of users in the cell C, and there is a shortage of radio resources. The access control is activated via a SIB of the cell C.

3. In the above process, a congestion situation has occurred in the cell C, but the congestion situation does not occur in the cell D.

4. Since the congestion situation has not yet occurred in the cell D, the eNB N decides that the cell D can additionally provide communication services, and determines to provide radio services via the cell D.

5. To this end, the eNB N maintains the access control activated in the cell C, and updates the SIB so that the UE simultaneously supporting an E-UTRA operation and the NR in the FB2 can alleviate or skip the access control mechanism. For example, in case of access control barring (ACB), while the UE not supporting the NR and the FB2 indicates to perform the access control mechanism by still applying the ACB, the UE supporting the NR and the FB2 indicates to skip the ACB.

6. The UEs A and B receive the updated SIB. Afterwards, data is generated in the respective UEs, and the respective UEs determine which access control mechanism they apply or skip. That is, the UE decides whether it meets a skip condition of an access barring check operation included in the SIB and thus determines whether to apply or skip the access control mechanism.

In the above process, since the UE B does not support the NR/FB2, the UE B performs the ACB and then determines whether or not to access according to a result of checking. On the other hand, since the UE A has received information that a UE supporting the NR/FB2 in the SIB can skip the ACB, the UE A skips the ACB and thus immediately performs the access.

7. The eNB conforms that the UE A supports the NR/FB2, and provides radio services to the UE A using resources of the cell D. In the above process, since radio congestion has occurred in the cell C, the radio services using resources of the cell C can be minimized.

In the process described above, since the respective UEs can have different characteristic although the radio congestion situation has occurred in the cell C, the eNB can preferentially provide an access opportunity to, for example, the UE supporting the NR. Hence, since the process can increase the utilization of resources of the cell D which may not be used and may be wasted when the UE cannot get the access opportunity, it can improve the user satisfaction.

Even from the viewpoint of the communication system, rather than that all the UEs compete for the same resource, i.e., the access opportunity in the cell C in the congestion situation, the eNB can preferentially provide radio services to a UE capable of accessing another cell using radio resources of the cell D. Hence, since the number of UEs, that compete to get services on congested resources, gradually decreases, the radio congestion of the cell C can be wholly solved rapidly.

Since the services are provided to the UE A using the radio resources of the cell D, the congestion of the radio resources does not occur additionally in the cell C.

The above process has been described the method for solving the radio congestion using the NR radio access technology based on the E-UTRA cell, the present invention is not limited thereto and may use other combinations. The following shows several examples of the other combinations.
When a NR cell is a main cell and can additionally manage E-UTRA based radio resources, for example, when the NR cell is congested, a UE supporting the E-UTRA can preferentially get an access opportunity.
When an E-UTRA cell is a main cell and can additionally use another technology such as an unlicensed band or WLAN, for example, when the E-UTRA cell is congested, the E-UTRA cell can preferentially provide an access opportunity to a UE supporting the unlicensed band or the WLAN. In the same manner, similar operation may be applied to the NR cell instead of the E-UTRA cell.
In addition, various combinations are possible.

In addition to RAT/RAN that is a basic as described above, additionally accessed RAT/RAN may be referred to as secondary access.

Further, the above process has been described by taking the ACB as an example, the present invention is not limited thereto and may use other mechanisms such as extended access barring (EAB), application specific congestion control for data communication (ACDC), etc., in addition to the ACB.

In other words, the network gives additional field/condition information to each access mechanism and may inform the UE about in which case the access mechanism is skipped.

Further, as described above, by configuring/defining whether to support additional other RAT, or whether to support a specific frequency, or whether to support specific radio technology combinations (e.g., NR+EUTRA, NR+WLAN, EUTRA+WLAN, etc.) or NR or E-UTRA via an unlicensed band, or whether to support specific technology carrier aggregation (CA) or dual connectivity (DC) (e.g., ENDC (E-UTRA-NR dual connectivity), MRDC (Multi-RAT dual connectivity)) or the like, or whether to support the secondary access as a skip condition of an access barring check operation, whether a specific access mechanism is skipped may be determined based on this.

An example of an access operation of the UE to the network in accordance with the above-described embodiment will be described as the following. The following is merely an example, and other similar methods may be used.

1> if ‘skip condition for access barring’ (i.e., skip condition of access barring check operation) is present in a SIB, and a UE is satisfied with the above condition,

3> the UE considers access to a cell as not barred;

1> else, if the UE is establishing RRC connection for a mobile originating call:

2> the UE performs access barring check as specified in 5.3.3.11 of 3GPP TS 36.331 using a timer T303 as barring time “Tbarring” and ac-BarringForMO-Data as “access control (AC) barring parameter”;

2> if access to the cell is barred:

3> if SystemInformationBlockType2 (SIB2) includes ac-BarringForCSFB or the UE does not support circuit switched (CS) fallback:

4> the UE informs upper layers about the failure to establish the RRC connection or failure to resume the RRC connection with suspend indication and that access barring for mobile originating call is applicable, upon which the procedure ends;

3> else (SIB2 does not include ac-BarringForCSFB and the UE supports CS fallback):

4> if a timer T306 is not running, the UE starts the timer T306 with a timer value of the timer T303;

4> the UE informs upper layers about the failure to establish the RRC connection or failure to resume the RRC connection with suspend indication and that access barring for mobile originating call and mobile originating CS fallback are applicable, upon which the procedure ends;

1> else, if the UE is establishing the RRC connection for mobile originating signaling:

2> the UE performs access barring check as specified in 5.3.3.11 of 3GPP TS 36.331 using a timer T305 as “Tbarring” and ac-BarringForMO-Signalling as “AC barring parameter”;

2> if access to the cell is barred:

3> the UE informs upper layers about the failure to establish the RRC connection or failure to resume the RRC connection with suspend indication and that access barring for mobile originating signaling is applicable, upon which the procedure ends;

1> else, if the UE is establishing the RRC connection for mobile originating CS fallback:

2> if SIB2 includes ac-BarringForCSFB:

3> the UE performs access barring check as specified in 5.3.3.11 of 3GPP TS 36.331 using the timer T306 as “Tbarring” and ac-BarringForCSFB as “AC barring parameter”;

3> if access to the cell is barred:

4> the UE informs upper layers about the failure to establish the RRC connection or failure to resume the RRC connection with suspend indication and that access barring for mobile originating CS fallback is applicable, due to ac-BarringForCSFB, upon which the procedure ends;

2> else:

3> the UE performs access barring check as specified in 5.3.3.11 of 3GPP TS 36.331 using the timer T306 as “Tbarring” and ac-BarringForMO-Data as “AC barring parameter”;

3> if access to the cell is barred:

4> if the timer T303 is not running, the UE starts the timer T303 with a timer value of the timer T306;

4> the UE informs upper layers about the failure to establish the RRC connection or failure to resume the RRC connection with suspend indication and that access barring for mobile originating CS fallback and mobile originating call and mobile originating CS fallback are applicable, due to ac-BarringForMO-Data, upon which the procedure ends;

1> else, if the UE is establishing the RRC connection for mobile originating multimedia telephony service (MMTEL) voice, mobile originating MMTEL video, mobile originating SMSoIP (Short Message Service over Internet Protocol) or mobile originating SMS:

2> if the UE is establishing the RRC connection for mobile originating MMTEL voice and SIB2 includes ac-BarringSkipForMMTELVoice; or

2> if the UE is establishing the RRC connection for mobile originating MMTEL video and SIB2 includes ac-BarringSkipForMMTELVideo; or

2> if the UE is establishing the RRC connection for mobile originating SMSoIP or mobile originating SMS and SIB2 includes ac-BarringSkipForSMS:

3> the UE considers access to the cell as not barred;

2> else:

3> if establishmentCause received from upper layers is set to mo-Signalling (including the case that mo-Signalling is replaced by highPriorityAccess according to 3GPP TS 24.301 or by mo-VoiceCall according to the subclause 5.3.3.3 of 3GPP TS 36.331):

4> the UE performs access barring check as specified in 5.3.3.11 of 3GPP TS 36.331 using the timer T305 as “Tbarring” and ac-BarringForMO-Signalling as “AC barring parameter”;

4> if access to the cell is barred:

5> the UE informs upper layers about the failure to establish the RRC connection or failure to resume the RRC connection with suspend indication and that access barring for mobile originating signaling is applicable, upon which the procedure ends;

3> if establishmentCause received from upper layers is set to mo-Data (including the case that mo-Data is replaced by highPriorityAccess according to 3GPP TS 24.301 or by mo-VoiceCall according to the subclause 5.3.3.3 of 3GPP TS 36.331):

4> the UE performs access barring check as specified in 5.3.3.11 of 3GPP TS 36.331 using the timer T303 as “Tbarring” and ac-BarringForMO-Data as “AC barring parameter”;

4> if access to the cell is barred:

5> if SIB2 includes ac-BarringForCSFB, and the UE does not support CS fallback:

6> the UE informs upper layers about the failure to establish the RRC connection or failure to resume the RRC connection with suspend indication and that access barring for mobile originating call is applicable, upon which the procedure ends;

5> else (SIB2 does not include ac-BarringForCSFB and the UE supports CS fallback):

6> if the timer T306 is not running, the UE starts the timer T306 with a timer value of the timer T303;

6> the UE informs upper layers about the failure to establish the RRC connection or failure to resume the RRC connection with suspend indication and that access barring for mobile originating call and mobile originating CS fallback is applicable, upon which the procedure ends;

The access barring check specified in 5.3.3.11 of 3GPP TS 36.331 is described below.

1> if a timer T302 or “Tbarring” is running:

2> the UE considers access to the cell as barred;

1> else, if SIB2 includes “AC barring parameter”:

2> if SIB2 includes “skip condition for AC barring parameter”:

3> the UE checks whether it is satisfied with the skip condition for AC barring parameter;

3> if the UE is satisfied with the skip condition for AC barring parameter:

4> the UE considers access to the cell as not barred;

2> else, the UE has one or more access classes, as stored in a universal subscriber identity module (USIM), with a value in the range 11 to 15, and the one or more access classes is valid for the UE to use according to 3GPP TS 22.011 and 3GPP TS 23.122, and

2> if, for at least one of these valid access classes, the corresponding bit in ac-BarringForSpecialAC included in “AC barring parameter” is set to zero:

3> the UE considers access to the cell as not barred;

2> else:

3> the UE draws a random number ‘rand’ that is uniformly distributed in the range 0≤rand<1;

3> if ‘rand’ is lower than a value indicated by ac-BarringFactor included in “AC barring parameter”:

4> the UE considers access to the cell as not barred;

3> else,

4> the UE considers access to the cell as barred;

1> else:

2> the UE considers access to the cell as not barred;

1> if access to the cell is barred and the timer T302 and “Tbarring” are not running:

2> the UE draws a random number ‘rand’ that is uniformly distributed in the range 0≤rand<1;

2> the UE starts “Tbarring” with a timer value calculated as below using ac-BarringTime included in “AC barring parameter”:

“Tbarring”=(0.7+0.6*rand)*ac-BarringTime;

Extended access barring (EAB) check specified in 5.3.3.12 of 3GPP TS 36.331 is described below.

The UE performs as follows:

1> if SystemInformationBlockType14 (SIB14) is present and includes an EAB parameter eab-Param:

2> if ‘skip condition for EAB’ is included in the EAB parameter eab-Param:

3> if the UE is satisfied with ‘skip condition for EAB’:

4> the UE considers access to the cell as not barred;

2> else, if eab-Common is included in the EAB parameter eab-Param:

3> if the UE belongs to a category of the UE as indicated in eab-Category in eab-Common; and

3> if, for an access class of the UE with a value in the range 0 to 9, as stored in the USIM, the corresponding bit in eab-BarringBitmap included in eab-Common is set to one:

4> the UE considers access to the cell as barred;

3> else:

4> the UE considers access to the cell as not barred due to EAB;

2> else (EAB list per PLMN eab-PerPLMN-List is included in the EAB parameter eab-Param):

3> the UE selects an entry in the EAB list per PLMN eab-PerPLMN-List corresponding to PLMN selected by upper layers;

3> if EAB configuration eab-Config for PLMN is included:

4> if the UE belongs to a category of the UE as indicated in eab-Category included in the EAB configuration eab-Config; and

4> if, for an access class of the UE with a value in the range 0 to 9, as stored in the USIM, the corresponding bit in eab-BarringBitmap included in the EAB configuration eab-Config is set to one:

5> the UE considers access to the cell as barred;

4> else:

5> the UE considers access to the cell as not barred due to EAB;

3> else:

4> the UE considers access to the cell as not barred due to EAB;

1> else:

2> the UE considers access to the cell as not barred due to EAB;

Access barring check for Application specific Congestion control for Data Communication (ACDC) specified in 5.3.3.13 of 3GPP TS 36.331 is described below.

The UE performs as follows:

1> if the timer T302 is running:

2> the UE considers access to the cell as barred;

1> else, if SIB2 includes “ACDC barring parameter”:

1> if the UE is not satisfied with ‘skip condition for ACDC barring’ when ‘skip condition for ACDC barring’ is present, or if ‘skip condition for ACDC barring’ is not present:

2> the UE draws a random number ‘rand’ that is uniformly distributed in the range 0≤rand<1;

2> if ‘rand’ is lower than a value indicated by ac-BarringFactor included in “ACDC barring parameter”:

3> the UE considers access to the cell as not barred;

2> else:

3> the UE considers access to the cell as barred;

1> else:

2> the UE considers access to the cell as not barred;

1> if access to the cell is barred and the timer T302 is not running:

2> the UE draws a random number ‘rand’ that is uniformly distributed in the range 0≤rand<1;

2> the UE starts “Tbarring” with a timer value calculated as below using ac-BarringTime included in “ACDC barring parameter”:

“Tbarring”=(0.7+0.6*rand)*ac-BarringTime.

An example where condition (e.g., skip-condition-for-ac-barring) capable of skipping an access control mechanism is transferred to the UE in SystemInformationBlockType2 (SIB2) is described below.

SIB2 includes radio resource configuration information that is commonly applied to all the UEs. SIB2 further includes a UE timer and a constant related to functionality for a parameter provided in another SIB.

Table 2 illustrates a part of SIB2 information element (IE).

TABLE 2
-- ASN1START
SystemInformationBlockType2 ::= SEQUENCE {

| | |
|---|---|
| ac-BarringInfo | SEQUENCE { |

| | |
|---|---|
| skip-condition-for-ac-barring | barringSkipCondition |

| ac-BarringForEmergency | | BOOLEAN, | | |
|---|---|---|---|---|
| | ac-BarringForMO-Signalling | AC-BarringConfig | OPTIONAL, | -- Need |

OP

| | | | |
|---|---|---|---|
| ac-BarringForMO-Data | AC-BarringConfig | OPTIONAL | -- Need |

OP

| | | |
|---|---|---|
| } | OPTIONAL, | -- Need |

OP

| | |
|---|---|
| radioResourceConfigCommon | RadioResourceConfigCommonSIB, |
| ue-TimersAndConstants | UE-TimersAndConstants, |
| freqInfo | SEQUENCE { |

| | | | |
|---|---|---|---|
| ul-CarrierFreq | ARFCN-ValueEUTRA | OPTIONAL, | -- Need |

OP

| | |
|---|---|
| ul-Bandwidth | ENUMERATED {n6, n15, n25, n50, n75, n100} |

| | |
|---|---|
| OPTIONAL, | -- Need |

OP

| | |
|---|---|
| additionalSpectrumEmission | AdditionalSpectrumEmission |

| } , | | | |
|---|---|---|---|
| mbsfn-SubframeConfigList | MBSFN-SubframeConfigList | OPTIONAL, | -- Need |

OR

| timeAlignmentTimerCommon | TimeAlignmentTimer, | | |
|---|---|---|---|
| . . . , | | | |
| lateNonCriticalExtension | OCTET | STRING | (CONTAINING |

| | |
|---|---|
| SystemInformationBlockType2-v8h0-IEs) | OPTIONAL, |

| | | | | |
|---|---|---|---|---|
| [ [ | ssac-BarringForMMTEL-Voice-r9 | AC-BarringConfig | OPTIONAL, | -- Need |

OP

| | | | |
|---|---|---|---|
| ssac-BarringForMMTEL-Video-r9 | AC-BarringConfig | OPTIONAL | -- Need |

OP

| ] ], | | | | |
|---|---|---|---|---|
| [ [ | ac-BarringForCSFB-r10 | AC-BarringConfig | OPTIONAL | -- Need |

OP

| ] ], | | | | |
|---|---|---|---|---|
| [ [ | ac-BarringSkipForMMTELVoice-r12 | ENUMERATED (true) | OPTIONAL, | -- Need |

OP

| | | | |
|---|---|---|---|
| ac-BarringSkipForMMTELVideo-r12 | ENUMERATED (true) | OPTIONAL, | -- Need |

OP

| | | | |
|---|---|---|---|
| ac-BarringSkipForSMS-r12 | ENUMERATED (true) | OPTIONAL, | -- Need |

OP

| | |
|---|---|
| ac-BarringPerPLMN-List-r12 | AC-BarringPerPLMN-List-r12 |

OPTIONAL -- Need OP

| ] ] , | | | | |
|---|---|---|---|---|
| [ [ | voiceServiceCauseIndication-r12 | ENUMERATED (true) | OPTIONAL | -- Need |

OP

] ] ,
[ [

| | |
|---|---|
| skip-condition-for-acdc-barring | barringSkipCondition |

Table 3 represents descriptions of field included in the SIB2 IE illustrated in Table 2 above.

TABLE 3
SIB2 field descriptions

ac-BarringFactor
If the random number drawn by the UE is lower than this value, access is
allowed. Otherwise the access is barred. The values are interpreted in the
range that is equal to 0 or less than 1. p00 = 0, p05 = 0.05, p10 =
0.10, . . ., p95 = 0.95.
Values other than p00 can only be set if all bits of the corresponding ac-
BarringForSpecialAC are set to 0.
ac-BarringForCSFB
Access control barring for mobile originating CS fallback
ac-BarringForEmergency
Access control barring for access class 10
ac-BarringForMO-Data
Access control barring for mobile originating calls
ac-BarringForMO-Signalling
Access control barring for mobile originating signaling
ac-BarringForSpecialAC
Access control barring for access class 11-15. The first/leftmost bit is for
access class 11, the second bit is for access class 12, and so on.
ac-BarringTime
Mean access barring time value in seconds
acdc-BarringConfig
Barring configuration for an ACDC category. If the field is absent, access
to the cell is considered as not barred for the ACDC category.
acdc-Category
indicates the ACDC category.
ssac-BarringForMMTEL-Video
Service specific access class barring for MMTEL video originating calls
ssac-BarringForMMTEL-Voice
Service specific access class barring for MMTEL voice originating calls

SystemInformationBlockType14 (SIB14) includes an EAB parameter.

Table 4 illustrates a part of SIB14 IE.

TABLE 4
-- ASN1START

| | |
|---|---|
| SystemInformationBlockType14-r11 : := | SEQUENCE { |

| | |
|---|---|
| eab-Param-r11 | CHOICE { |

| | |
|---|---|
| skip-condition-for-eab | barringSkipCondition |
| eab-Common-r11 | EAB-Config-r11, |
| eab-PerPLMN-List-r11 | SEQUENCE (SIZE (1. .maxPLMN-r11)) OF EAB-ConfigPLMN-r11 |

}

OPTIONAL, -- Need OR

| | | |
|---|---|---|
| lateNonCriticalExtension | OCTET STRING | OPTIONAL, |

. . .
}

| | |
|---|---|
| EAB-ConfigPLMN-r11 : : = | SEQUENCE { |

| | | |
|---|---|---|
| eab-Config-r11 | EAB-Config-r11 | OPTIONAL-- Need OR |

}

| | |
|---|---|
| EAB-Config-r11 : : = | SEQUENCE { |

| | |
|---|---|
| eab-Category-r11 | ENUMERATED {a, b, c}, |
| eab-BarringBitmap-r11 | BIT STRING (SIZE (10)) |

}
-- ASN1STOP

Table 5 illustrates barringSkipCondition (i.e., skip condition of access barring check operation) in skip-condition-for-ac-barring field illustrated in Table 2 and Table 4 above.

TABLE 5

| | |
|---|---|
| barringSkipCondition :: = | SEQUENCE { |
| supportOfENDC | SupportofENDC |
| supportOfLAA | SupportofLAA |
| supportOfLWA | SupportofLWA |
| supportOfMRDC | SupportofMRDC |
| supportOfNR | SupportofNR |

Table 6 represents descriptions of barringSkipCondition (i.e., skip condition of access barring check operation) field illustrated in Table 5 above.

TABLE 6
barringSkipCondition field descriptions

SupportofENDC
SupportofENDC represents whether the UE supports E-UTRA-NR Dual
Connectivity (ENDC). Optionally, frequency information can be added.
If SupportofENDC is set to Yes or skip, or SupportofENDC is present,
the UE can skip associated access control mechanism/operation and can
consider a cell as not barred.
SupportofLAA
SupportofLAA represents whether the UE supports Licensed Assisted
Access (LAA). Optionally, frequency information can be added.
If SupportofLAA is set to Yes or skip or SupportofLAA is present, the
UE can skip associated access control mechanism/operation and can
consider a cell as not barred.
SupportofLWA
SupportofLWA represents whether the UE supports LTE-WLAN
Aggregation (LWA). Optionally, frequency information can be added.
If SupportofLWA is set to Yes or skip or SupportofLWA is present, the
UE can skip associated access control mechanism/operation and can
consider a cell as not barred.
SupportofMRDC
SupportofMRDC represents whether the UE supports Multi-RAT Dual
Connectivity (MRDC). Optionally, frequency information can be added.
If SupportofMRDC is set to Yes or skip or SupportofMRDC is present,
the UE can skip associated access control mechanism/operation and can
consider a cell as not barred.
SupportofNR
SupportofNR represents whether the UE supports New RAT (NR).
Optionally, frequency information can be added.
If SupportofNR is set to Yes or skip or SupportofNR is present, the UE
can skip associated access control mechanism/operation and can consider
a cell as not barred.

In addition, in the process described above, with regard to network slicing, condition capable of skipping access control may be used with information such as network slice selection assistance information (N-SSAI) (e.g., N-SSAI related field is defined, and if the N-SSAI related field is set to Yes or skip or the corresponding field is present, the UE can skip associated access control mechanism/operation and can consider the cell as not barred), slice/service type (SST) (this represents the expected network slice operation in terms of features and services) (e.g., SST related field is defined, and if the SST related field is set to Yes or skip or the corresponding field is present, the UE can skip associated access control mechanism/operation and can consider the cell as not barred), slice differentiator (SD) (this is information that complements SST to identify multiple network slices of the same SST) (e.g., SD related field is defined, and if the SD related field is set to Yes or skip or the corresponding field is present, the UE can skip associated access control mechanism/operation and can consider the cell as not barred), or the like.

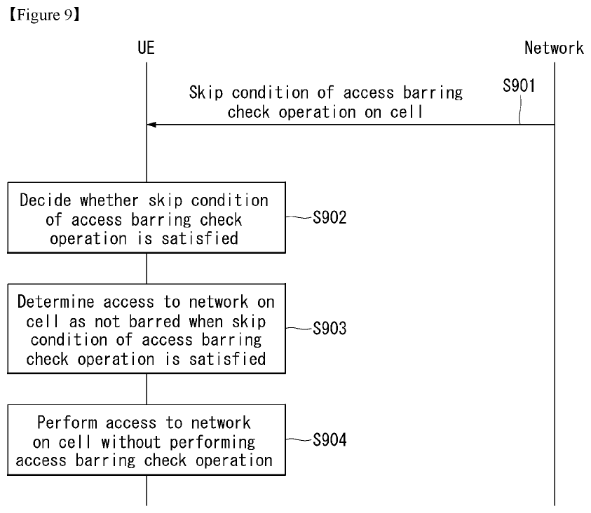

FIG. 9 illustrates a method of accessing a network according to an embodiment of the present invention.

Referring to FIG. 9, the UE receives from a (wireless) network (e.g., base station) a skip condition of access barring check operation on a cell supported by the corresponding (wireless) network in S901.

Herein, the skip condition of access barring check operation may include one or more of the support of ENDC, the support of MRDC, the support of LAA, the support of LWA, or the support of NR. In this instance, as described above, a field for each condition is defined, and the corresponding field is set to Yes or skip or the corresponding field is present (for example, in SIB), it may mean that the corresponding condition has been activated (i.e., it has to be decided whether the UE is satisfied with the corresponding condition).

The skip condition of access barring check operation may further include one or more of the support of additional other RAT, the support of specific frequency, the support of specific radio technology combination (e.g., NR+EUTRA, NR+WLAN, EUTRA+WLAN, etc.) or NR or E-UTRA via a unlicensed band, or the support of specific CA or DC (e.g., ENDC, MRDC) or the like. In the same manner, a field for each condition is defined, and the corresponding field is set to Yes or skip or the corresponding field is present (for example, in SIB), it may mean that the corresponding condition has been activated (i.e., it has to be decided whether the UE is satisfied with the corresponding condition).

In this instance, one or more skip conditions of access barring check operation may be configured for each cell. That is, when the (wireless) network (e.g., base station) supports a plurality of cells, a skip condition of access barring check operation may be different for each cell. For example, when the (wireless) network (e.g., base station) supports cells A and B, conditions a and b may be configured for the cell A, and conditions a, c and d may be configured for the cell B.

Further, a plurality of access control operations including ACB, EAB, ACDC, etc. can be used (i.e., defined). In this case, one or more skip conditions of access barring check operation may be configured for each access barring check operation. That is, a skip condition of access barring check operation may be different for each access barring check operation. For example, when access barring check operations of ACB and EAB are used (i.e., defined), conditions a and c may be configured for the access barring check operation ACB, and conditions b, c and d may be configured for the access barring check operation EAB.

Further, one or more skip conditions of access barring check operation may be configured for each cell and for each access barring check operation. That is, when the (wireless) network (e.g., base station) supports a plurality of cells, a different (or the same) access barring check operation may be used (i.e., defined) for each cell, and a skip condition of access barring check operation may be different for each access barring check operation. For example, when the (wireless) network (e.g., base station) supports cells A and B and ACB and ACDC are used (i.e., defined) commonly to all the cells, conditions a and b may be configured for the ACB of the cells A and B, and conditions a, c and d may be configured for the ACDC of the cells A and B. Further, when the base station supports the cells A and B, EAB is used (i.e., defined) for the cell A, and EAB and ACDC are used (i.e., defined) for the cell B, the conditions a and b may be configured for the EAB of the cell A, the conditions b, c and d may be configured for the EAB of the cell B, and the conditions a and d may be configured for the ACDC of the cell B.

Herein, the skip condition of access barring check operation may be transmitted via SIB.

The UE decides whether it is satisfied with the skip condition of access barring check operation in S902.

For example, if the skip condition of access barring check operation includes one or more of the support of ENDC, the support of MRDC, the support of LAA, the support of LWA, or the support of NR (or if the corresponding field is set to Yes or skip), it is decided whether the UE is satisfied with one or more of the corresponding conditions (i.e., whether the UE supports ENDC/MRDC/LAA/LWA/NR).

If the skip condition of access barring check operation includes one or more of the support of additional other RAT, the support of specific frequency, the support of specific radio technology combination (e.g., NR+EUTRA, NR+WLAN, EUTRA+WLAN, etc.) or NR or E-UTRA via a unlicensed band, or the support of specific CA or DC (e.g., ENDC, MRDC) or the like (or if the corresponding field is set to Yes or skip), it is decided whether the UE is satisfied with one or more of the corresponding conditions.

If the skip condition of access barring check operation is satisfied, the UE determines access to the (wireless) network (i.e., base station/cell) on the cell as not barred in S903.

On the other hand, if the skip condition of access barring check operation is not satisfied, the UE performs access to the (wireless) network of the UE described above and determines whether access to the cell is barred.

The UE performs access to the (wireless) network (i.e., base station/cell) on the cell without performing the access barring check operation in S904.

Herein, as described above, the access barring check operation may include one or more of ACB, EAB, and ACDC.

In the embodiment described above, the UE determines whether or not an access control mechanism is applied according to the skip condition of access barring check operation indicated on the cell in a state of not knowing what access technology is supported by a cell on which the UE is currently camping, and then operates according to a result of determination.

However, in the above process, since radio congestion has occurred in a cell on which the UE camps, it is good to minimize the transmission and reception via the cell. Thus, in the above process, it is preferable to use other radio resources and other radio access functions as soon as possible. However, at the initial RRC connection, the network cannot know which access control mechanism the UE has performed, or which access control mechanism the UE has skipped. Thus, since the network does not actually know which radio resource the UE supports and which radio access technology the UE supports, the UE continuously performs transmission reception operations in the above cell, thereby causing additional radio congestion.

Accordingly, in the above process, in such a congestion situation, when the UE skips any access control mechanism and actually accesses to the wireless network, the UE may inform the wireless network of it. Based on this, the (wireless) network can more efficiently allocate radio resources to the UE.

In particular, in access to the (wireless) network of a certain UE, as in the embodiment described above, when the UE is satisfied with skip condition of specific access barring check operation and attempts access to the (wireless) network without applying the specific access barring check operation, the UE may inform the (wireless) network of information about skipped access control mechanism/operation, for example, information about which access control mechanism/operation the UE has skipped or why the UE has skipped the access control mechanism/operation, or which skip condition of the access barring check operation the UE has been satisfied.

Alternatively, there may be another method for defining a separate access control mechanism/operation applied even when the UE supports secondary access, and applying only the separate access control mechanism/operation to the UE supporting the secondary access.

Further, the UE may transmit to the (wireless) network information about whether the UE supports the secondary access, and which RAT is supported by the UE if the UE supports the secondary access in a RRC Connection Request message or a RRC Connection setup complete message, or a message of purpose similar to this. Hence, the network can rapidly configure the secondary access to the UE.

For example, the following is an example to which an embodiment proposed by the present invention is applied.

1. The steps 1 to 6 described above are performed.

2. The UE performs a random access procedure (so-called random access channel (RACH) procedure) in a process for performing the access. The UE sends, for example, a RRC Connection Request message through the procedure.

Optionally, in the above process, the UE may transmit information about which RRC access control mechanism/operation in the RRC Connection Request message the UE has skipped. Alternatively, the UE may send the RRC Connection Request message by including, in the RRC Connection Request message, information about which of the skip condition of access barring check operation has been satisfied.

The (wireless) network receives the RRC Connection Request message from the UE. In the above process, the network can know which RRC access control mechanism/operation the UE has skipped or why the UE has skipped the access control mechanism/operation by analyzing the message. Hence, the network can know which function the UE can support. This may be implemented in various methods, and may use a separate field in the RRC message and use additional code point to an existing establishment cause.

For example, because the UE supports the NR, when the UE informs that the access control mechanism has been skipped, and when a congestion situation occurs in a cell in which the UE performs the access to the network, the network immediately allocates radio resources using the NR to the UE and thus can prevent the congestion situation from occurring in EUTRA Cell.

As other method besides the method proposed above, in the above process, the network may allocate some of RACH radio resources (i.e., radio resources capable of being allocated to the UE in a random access procedure) for the UE that skips the access control mechanism/operation. In this instance, when the network informs the UE of information about the RACH radio resources, the network can additionally inform the UE of which RACH radio resources can be used under certain conditions.

For example, a RACH preamble may be used as an example of the RACH radio resources. For example, when the UE supports the NR, the network may indicate to the UE that the UE uses the RACH preamble ten times. In this case, when the UE supports the NR, the UE may use the RACH preamble. In this case, the network can provide radio services to the UE, that uses the RACH preamble ten times, immediately using NR radio resources, and at the same time can suppress additional congestion in the E-UTRA cell.

That is, the method allocates radio resources according to conditions of the UE, and uses the radio resources when the UE is satisfied with the conditions.

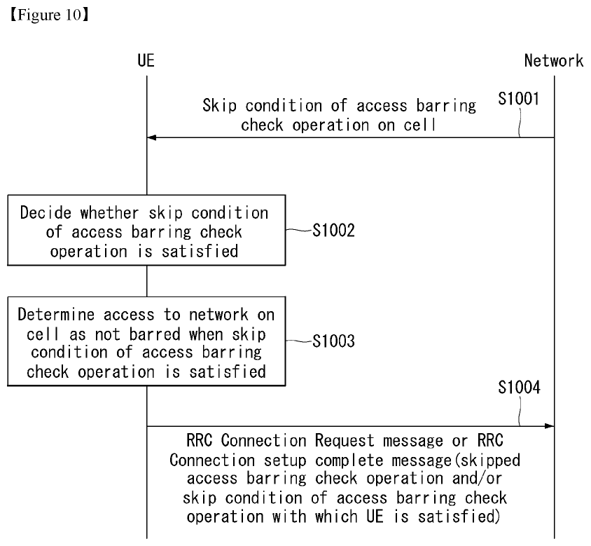

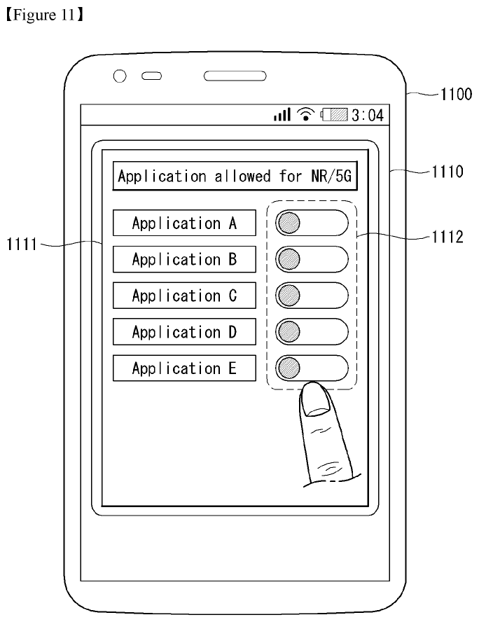

FIG. 10 illustrates a method of accessing a network according to an embodiment of the present invention.

Referring to FIG. 10, the UE receives from a (wireless) network (e.g., base station) a skip condition of access barring check operation on a cell supported by the corresponding (wireless) network in S1001.

Herein, the skip condition of access barring check operation may include one or more of the support of ENDC, the support of MRDC, the support of LAA, the support of LWA, or the support of NR. In this instance, as described above, a field for each condition is defined, and the corresponding field is set to Yes or skip or the corresponding field is present (for example, in SIB), it may mean that the corresponding condition has been activated (i.e., it has to be decided whether the UE is satisfied with the corresponding condition).

The skip condition of access barring check operation may further include one or more of the support of additional other RAT, the support of specific frequency, the support of specific radio technology combination (e.g., NR+EUTRA, NR+WLAN, EUTRA+WLAN, etc.) or NR or E-UTRA via a unlicensed band, or the support of specific CA or DC (e.g., ENDC, MRDC) or the like. In the same manner, a field for each condition is defined, and the corresponding field is set to Yes or skip or the corresponding field is present (for example, in SIB), it may mean that the corresponding condition has been activated (i.e., it has to be decided whether the UE is satisfied with the corresponding condition).

In this instance, one or more skip conditions of access barring check operation may be configured for each cell. That is, when the (wireless) network (e.g., base station) supports a plurality of cells, a skip condition of access barring check operation may be different for each cell.

Further, a plurality of access control operations including ACB, EAB, ACDC, etc. can be used (i.e., defined). In this case, one or more skip conditions of access barring check operation may be configured for each access barring check operation. That is, a skip condition of access barring check operation may be different for each access barring check operation.

Further, one or more skip conditions of access barring check operation may be configured for each cell and for each access barring check operation. That is, when the (wireless) network (e.g., base station) supports a plurality of cells, a different (or the same) access barring check operation may be used (i.e., defined) for each cell, and a skip condition of access barring check operation may be different for each access barring check operation.

Herein, the skip condition of access barring check operation may be transmitted via SIB.

The UE decides whether it is satisfied with the skip condition of access barring check operation in S1002.

For example, if the skip condition of access barring check operation includes one or more of the support of ENDC, the support of MRDC, the support of LAA, the support of LWA, or the support of NR (or if the corresponding field is set to Yes or skip), it is decided whether the UE is satisfied with one or more of the corresponding conditions (i.e., whether the UE supports ENDC/MRDC/LAA/LWA/NR).

If the skip condition of access barring check operation includes one or more of the support of additional other RAT, the support of specific frequency, the support of specific radio technology combination (e.g., NR+EUTRA, NR+WLAN, EUTRA+WLAN, etc.) or NR or E-UTRA via a unlicensed band, or the support of specific CA or DC (e.g., ENDC, MRDC) or the like (or if the corresponding field is set to Yes or skip), it is decided whether the UE is satisfied with one or more of the corresponding conditions.

If the skip condition of access barring check operation is satisfied, the UE determines access to the (wireless) network (i.e., the cell) on the cell as not barred in S1003.

On the other hand, if the skip condition of access barring check operation is not satisfied, the UE performs access to the (wireless) network of the UE described above and determines whether access to the cell is barred.

The UE performs access to the (wireless) network (i.e., the cell) on the cell without performing the access barring check operation. That is, the UE may perform a random access procedure (see FIG. 4) in order to perform access to the (wireless) network in S1004.

During the random access procedure, the UE transmits to the (wireless) network a RRC Connection Request message, a RRC Connection setup complete message, or a message of purpose similar to this. In this instance, the UE may transmit to the (wireless) network information on the access control mechanism/operation skipped by the UE and/or information on skip condition of access barring check operation, with which the UE is satisfied, by including them in the above message.

Further, the (wireless) network may allocate some radio resources, that are usable in the random access procedure, to the UE that is satisfied with skip condition of specific access barring check operation. For example, the (wireless) network may previously allocate random access preamble resources to the UE that is satisfied with the skip condition of specific access barring check operation. This may be promised in advance. In this case, when the UE is satisfied with the skip condition of specific access barring check operation, the UE may transmit to the (wireless) network a random access preamble on the previously allocated random access preamble resource.

In another embodiment for solving the above-described problems, when the UE performs a process of performing registration or ATTACH or a procedure such as tracking area update (TAU), the network may inform the UE of whether or not the UE can skip any access control mechanism/operation in a certain case.

For example, because there may be a (wireless) network that does not have authorization information of a certain UE, the network can previously designate a certain case where the certain UE skips an access control mechanism/operation when the certain UE performs registration on the network.

Using this, the wireless network can be relieved of the burden of determining whether or not to allow a certain UE to actually access using another radio access technology. In particular, even if a certain user has a UE supporting both, for example, NR and LTE, the NR should not be used in access using the UE when the user has only an LTE contract to an actual mobile carrier, and the UE should not skip an access barring check operation even if an access control skip condition includes the NR support. Thus, when the UE performs the access in a certain cell, the UE can skip the application of the corresponding access control mechanism/operation only under conditions, which are previously allowed to the UE from the network, only when the skip operation is actually allowed in the cell.

In the above process, quality of radio access services capable of being provided in a cell which the UE accesses may be different from quality of radio access services capable of being provided through a cell other than the cell or other radio access technology. In this case, if the quality of radio access services capable of being provided through the other cell or the other radio access technology is better, the mobile carriers can perform additional billing. If the quality of radio access services capable of being provided through the other cell or the other radio access technology is lower, this may lead to a user's service quality dissatisfaction.

In particular, unlike the case where services are provided via a licensed band, when, for example, a video call is provided via an unlicensed band, this may lead to a user's dissatisfaction. Thus, in this case, even if the skip of access control is allowed for the UE and the UE can easily perform access, the UE must not attempt to actually connect or access.

Accordingly, to additionally solve such a problem, in the present invention, the network can additionally inform the UE of the following in a process of informing the UE of information about whether the UE can use a skip function of access control. In the above process, the UE skips the access control only if the following information is matched, and otherwise has to apply the access control.
Information about whether to use a function to skip any access control when data to be transmitted has occurred in a certain application

Additionally, the network may inform the UE of feature information about the application, for example, Internet Protocol (IP) address, port number, application identification, and the like.

However, for all of applications, the network or the mobile carrier cannot understand which data generation feature each application has, or data transfer requirements, QoS (Quality of Service) requirements, etc. required by each application.

For example, the following conditions may be considered.
Supposing that a certain UE supports LTE and NR
Informing that the UE accesses a LTE cell, and the LTE cell can provide services using a NR access method. Congestion has occurred in the LTE cell due to a large number of users. Hence, it is determined that the LTE cell allows a UE supporting NR to preferentially access in spite of the congestion.

In such a situation, according to an application, in the above case, it is not always preferable that the UE supporting both LTE and NR attempts to access and receives services with NR. For example, due to access schemes and frequency characteristics, a radius of a wireless base station in a NR based cell is smaller than that in a LTE based cell. In case of instant message service, since it is relatively insensitive to a transfer delay, the user's satisfaction does not rapidly deteriorate even if a part of coverage of a NR scheme is not provided. On the other hand, in case of watching video streaming, when it goes out of coverage of NR in a process of receiving streaming with NR, particularly, when congestion occurs in the LTE cell as described above, streaming service of the user may be abruptly terminated.

Similar problems may occur in various situations such as a mixed situation of LTE, NR, and WIFI. Further, because the preferences for service attributes in each application may be different for each user, there is a need for a method in which the user directly performs configuration about access to user's UE to solve this.

The following is an example of operation according to the present invention.

Step 1: The UE can receive from a user an input as to whether or not access is possible for each application and/or each radio access technology.

FIG. 11 illustrates a screen of a user equipment according to an embodiment of the present invention.

For example, a UE 1100 may display, on a display unit 1110, a setting screen that receives from the user a setting that indicates whether or not the UE has to (or can) perform access (for each application) in a certain case.

On the setting screen, the UE may receive from the user whether or not access is possible for each radio access technology of the corresponding UE through a user input unit. The display unit 1110 may be implemented as a touch screen, etc. and may serve as the user input unit. At the same time, when an output interface is provided between the UE 1100 and the user, the display unit 1110 may receive from the user whether or not access is possible for each application and each radio access technology of the corresponding UE, by a touch input on the setting screen.

It is assumed that the user has been configured to the UE so that radio access is not allowed for a certain application, for example, NR of the corresponding UE and is allowed for LTE. When the UE camps on a certain LTE cell and access is allowed for the UE supporting NR in the LTE cell, the UE does not attempt the radio access or RRC connection configuration even if data is generated in the application of the UE.

FIG. 11 illustrates a screen of a display unit of a mobile terminal. The screen is merely an example, and the use of LTE, Wifi, and unlicensed band as well as NR (New RAT) can be configured.

As illustrated in FIG. 11, the UE may display, on the display unit 1110, a setting screen 1111 that indicates which radio access technology each application of a certain UE or the above UE can use, or which application a specific radio access technology can use.

One or more application names may be displayed on the setting screen 1111, and buttons 1112 may be displayed on the display unit 1110 and may be used for the user to choose whether or not a specific radio access technology is allowed to be used for each application. The button 1112 may be a toggle button or as flip-flop button as illustrated in FIG. 11, or may be an Allow (or active) button and a Block (or inactive) button. However, this is merely an example and may be displayed as different types of buttons for receiving the user's choice.

On the setting screen 1111, an application list may be displayed, which is allowed to be used for each specific access technology previously configured in a mobile terminal according to the policy of the mobile carrier to which the mobile terminal is subscribed.

Alternatively, the application list may display which radio access technologies has been allowed to be used or has not been allowed to be used for each application, rather than displaying that the application is configured for each radio access technology as illustrated in FIG. 11.

Step 2: It is assumed that congestion occurs in a LTE cell where the corresponding UE stays. The corresponding cell broadcasts to the UE that the UE can skip an access control when the UE supports NR or supports an ENDC function via a system information block (SIB).

Step 3: It is assumed that data has occurred in the corresponding UE.

The UE confirms which application has generated the data. In addition, the user checks whether the user has allowed the use of NR for the corresponding application according to the configuration achieved in the Step 1.

If the user has allowed the use of NR for the corresponding application, the UE skips application of an access control mechanism based on information of the Step 2 and the configuration of the Step 1 and then starts access to the LTE cell.

However, if the use of NR has been prohibited for the corresponding application according to the configuration of the user, the corresponding UE applies an access control mechanism, that the corresponding UE has to apply, among access control mechanisms activated by the corresponding LTE cell. Further, only when access to the corresponding cell is allowed after the corresponding access control mechanism is performed, the UE attempts access to the corresponding cell (e.g., starts a RRC connection establishment process).

In the following description of the present invention, an existing access or a first access means access to a network on a corresponding cell via a first radio access technology in order to receive services from the network, and a second access means access to the network on a corresponding cell via a second radio access technology different from the first radio access technology in order to receive services from the network.

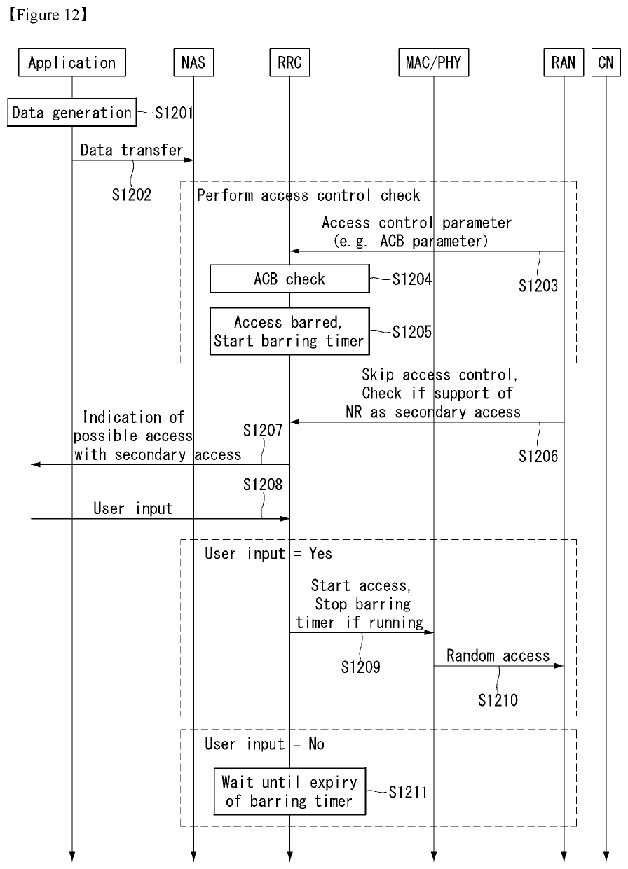

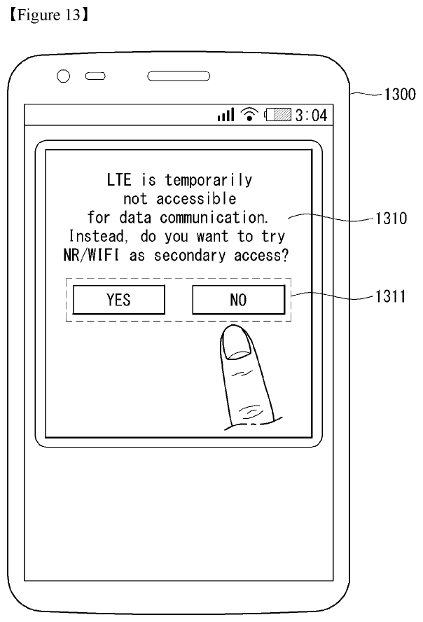

FIG. 12 illustrates a method of accessing a network according to an embodiment of the present invention.

Referring to FIG. 12, data to be transmitted to a network is generated in a specific application of a UE in S1201.

The data generated in the application of the UE is transferred to a NAS layer of the UE in S1202.

Subsequently, an access control check (i.e., access barring check operation) is performed.

The UE (e.g., RRC layer of the UE) receives a parameter (e.g., ACB parameter) related to access control from a base station (i.e., RAN) in S1203.

Alternatively, the UE may utilize a parameter value related to the previously received access control. In this case, the step S1203 may be skipped.

The UE performs the access control (i.e., access barring check) using the parameter value related to the access control received (or previously received and stored) in the step S1203 in S1204.

FIG. 12 illustrates ACB as an example of the access control (i.e., access barring check), but the present invention is not limited thereto.

For example, when the access class barring (ACB) parameter is received in the step S1203, the UE checks whether access of the UE is allowed or barred using a value included in the parameter.

In this instance, if the corresponding UE is camping on a LTE cell, the corresponding UE performs an access control check (i.e., access barring check) in the LTE cell.

The UE assumes access to the LTE cell as barred according to a result of the step S1204. Hence, the UE cannot attempt access to the corresponding cell during a certain period of time and starts an access barring timer in relation to this in S1205.

That is, after the UE performs the access control (i.e., access barring check) in the corresponding LTE cell, the UE does not pass the access control check and is in a barred state.

The corresponding LTE cell informs that NR or other RAT is supported as secondary access (i.e., information that access to the network via secondary RAT is possible) via system information (e.g., SIB). When the corresponding cell uses NR or other RAT via the system information, the corresponding cell may provide a separate access control parameter used in the UE supporting the corresponding RAT as the secondary access. Alternatively, the corresponding cell may transmit information, that the UE can skip the access control (i.e., access barring check operation), to the UE supporting a corresponding function (i.e., secondary access) in S1206.

The UE cannot use the LTE in the corresponding cell to receive services from the network, but knows that it can use other RAT.

The corresponding UE informs the user of it. That is, the corresponding UE informs/notifies the user that access via the LTE is impossible, but access services can be provided via the secondary access such as NR or WIFI (i.e., service access via the secondary access is possible), in S1207. In this instance, the UE may notify the user of it by displaying it on the screen as illustrated in FIG. 13 below, or may notify the user of it through alarm, vibration, etc., in case of a device not having a display.

This is described below with reference to the following figures.

FIG. 13 illustrates a screen of a user equipment according to an embodiment of the present invention.

For example, a UE 1300 may display, on a display unit, a message/screen 1310 that informs a user that access via specific RAT is difficult in a cell that is currently camping on, or informs the user that data transmission/reception is currently difficult via the specific RAT, but data transmission/reception is possible via other secondary RAT. Further, the UE 1300 may additionally display information about whether the user will attempt other RAT and a button 1311 that the user can select. The UE 1300 may receive, from the user, a response as to whether to start data transmission/reception using other RAT different from the RAT of the cell that is currently camping on.

Referring again to FIG. 12, if the UE receives from the user an input (i.e., an input as to whether to allow service access via the secondary access), user input information is transferred to the RRC layer of the UE in S1208.

Afterwards, the UE performs operation according to the input of the user identified in the previous step.

If the user input is “Yes” (i.e., attempting access via the secondary access) (if the user selects service access via the secondary access), steps S1209 and S1210 are performed.

If the user wants a data access attempt via other RAT (i.e., secondary access), the UE starts a RRC connection establishment procedure in the corresponding cell in S1209. In the procedure, the base station may additionally transfer information that indicates presenting or skipping a separate access control parameter applied to only UEs requesting data transmission/reception via secondary access RAT. In this case, the corresponding UE attempts the access using the information.

To inform that access to the corresponding cell is access for secondary access, i.e., not the currently accessed RAT but other RAT such as NR or WIFI controlled in a current cell or RAN, for example, in a process of starting the RRC connection establishment procedure, the UE includes related information in a RRC connection request message or a message equivalent to the message.

In this instance, in the above process, a part of an access control related function may be performed even in the NAS layer instead of the RRC layer.

In conjunction with the step S1209, the MAC/PHY layer of the UE starts a random access procedure (so-called random access channel (RACH) procedure) to transmit real information in S1210.

On the other hand, if the user input is “No” (i.e., not attempting access via the secondary access) (if the user does not select service access via the secondary access), step S1211 is performed.

If the user denies a data access attempt via other RAT, the UE waits until an access barring timer expires in the corresponding cell in S1211.

As illustrated in FIG. 12 above, the UE first performs a basic access control check function/operation in the steps S1203 to S1205 and then additionally confirms that it can obtain an additional access opportunity via the secondary access such as NR/WIFI as in the step S1206. Other methods are possible. For example, when the UE can preferentially use the secondary access based on information of the step S1206, the UE can preferentially check whether to skip the access control check. In this case, the UE first performs the step S1206. Then, if such a function is not supported or the user selects ‘No’ through the steps S1207 and S1208, the UE can perform the access control check as in the steps S1203 to S1205, and if the user selects ‘Yes’, the UE can skip the access control check.

This is described in more detail below with reference to the following figures.

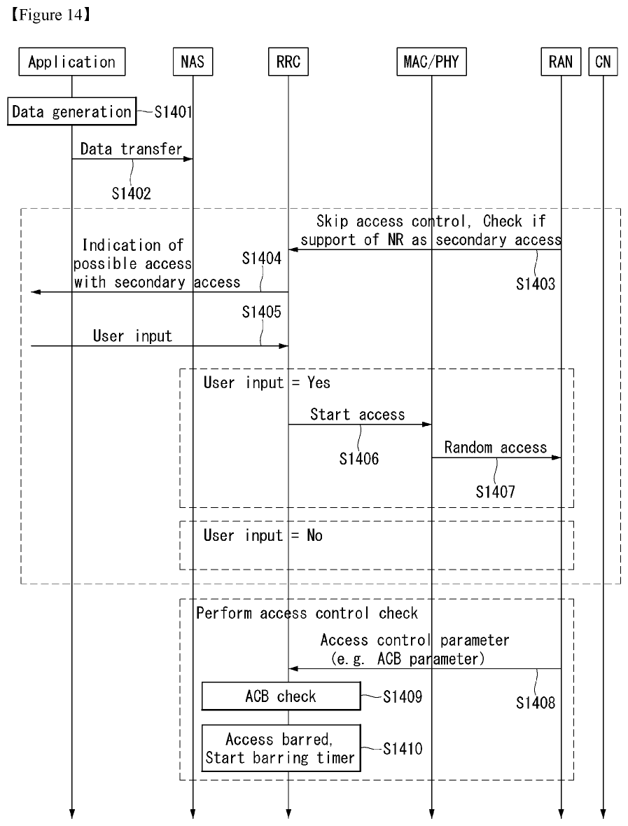

FIG. 14 illustrates a method of accessing a network according to an embodiment of the present invention.

Referring to FIG. 14, data to be transmitted to the network is generated in a specific application of the UE in S1401.

The data generated in the application of the UE is transferred to the NAS layer of the UE in S1402.

The corresponding LTE cell informs that NR or other RAT is supported as secondary access (i.e., information that access to the network via secondary RAT is possible) via system information (e.g., SIB). When the corresponding cell uses NR or other RAT via the system information, the corresponding cell may provide a separate access control parameter used in the UE supporting the corresponding RAT as the secondary access. Alternatively, the corresponding cell may transmit information, that the UE can skip the access control (i.e., access barring check), to the UE supporting a corresponding function (i.e., secondary access) in S1403.

When the skip is possible in the step S1403, steps S1404 to S1407 are performed. On the other hand, when there is no information that the skip is possible in the step S1403, steps S1408 to S1410 are performed.

That is, a process of asking an intention of the user is actually performed when the skip of access control in a cell is possible for specific UEs. If the UE receives information that the skip is actually possible through the step S1403, the UE additionally performs the steps S1404 and S1405. According to a result of the step S1405, when the user wants the access, the UE additionally performs the steps S1406 and S1407 and does not perform the steps S1408 to S1410. However, when the user does not want the access or does not allow the skip in the cell through the step S1403, the UE performs the steps S1408 to S1410.

If the access control skip is possible in the step S1403, the corresponding UE informs/notifies the user of it. That is, the corresponding UE informs/notifies the user that the UE can receive access services via secondary access such as NR or WIFI in S1404. In this instance, the UE may notify the user of it by displaying it on the screen as illustrated in FIG. 13 below, or may notify the user of it through alarm, vibration, etc., in case of a device not having a display.

If the UE receives an input from the user, user input information is transferred to the RRC layer of the UE in S1405.

If the user wants a data access attempt via other RAT, the UE starts a RRC connection establishment procedure in the corresponding cell in S1406. In the procedure, the base station may additionally transfer information that indicates presenting or skipping a separate access control parameter applied to only UEs requesting data transmission/reception via secondary access RAT. In this case, the corresponding UE attempts the access using the information.

To inform that access to the corresponding cell is access for secondary access, i.e., not the currently accessed RAT but other RAT such as NR or WIFI controlled in a current cell or RAN, for example, in a process of starting the RRC connection establishment procedure, the UE includes related information in a RRC connection request message or a message equivalent to the message.

In this instance, in the above process, a part of an access control related function may be performed even in the NAS layer instead of the RRC layer.

In conjunction with the step S1406, the MAC/PHY layer of the UE starts a random access procedure (so-called random access channel (RACH) procedure) to transmit real information in S1407.

On the other hand, if the user input is “No” (i.e., not attempting access via the secondary access) and if the user does not perform the access via the secondary access, it starts from step S1408. Further, if the access control skip is not possible in the step S1403, it starts from the step S1408.

The UE (e.g., the RRC layer of the UE) receives a parameter (e.g., ACB parameter) related to the access control from the base station (i.e., RAN) in S1408.

Alternatively, the UE may utilize a parameter value related to the access control that is previously received. In this case, the step S1408 may be skipped.

The UE performs access control (i.e., access barring check) using a parameter value related to access control received (or previously received and stored) in the step S1408 in S1409.

FIG. 14 illustrates ACB as an example of the access control (i.e., access barring check), but the present invention is not limited thereto.

For example, when the ACB (access class barring) parameter is received in the step S1408, the UE checks whether access of the UE is allowed or barred using a value included in the parameter.

In this instance, if the corresponding UE is camping on a LTE cell, the corresponding UE performs an access control check (i.e., access barring check) in the LTE cell.

The UE assumes access to the LTE cell as barred according to a result of the step S1409. Hence, the UE cannot attempt access to the corresponding cell during a certain period of time and starts an access barring timer in relation to this in S1410.

That is, after the UE performs the access control (i.e., access barring check) in the corresponding LTE cell, the UE does not pass the access control check and is in a barred state.

The example illustrated above has described that the UE receives, via the system information, whether the ‘skip’ is possible, and has illustrated the access control process. However, as described above, a transfer of a separate access control parameter is possible for UE(s) having a specific performance. This is described below with reference to the following figures.

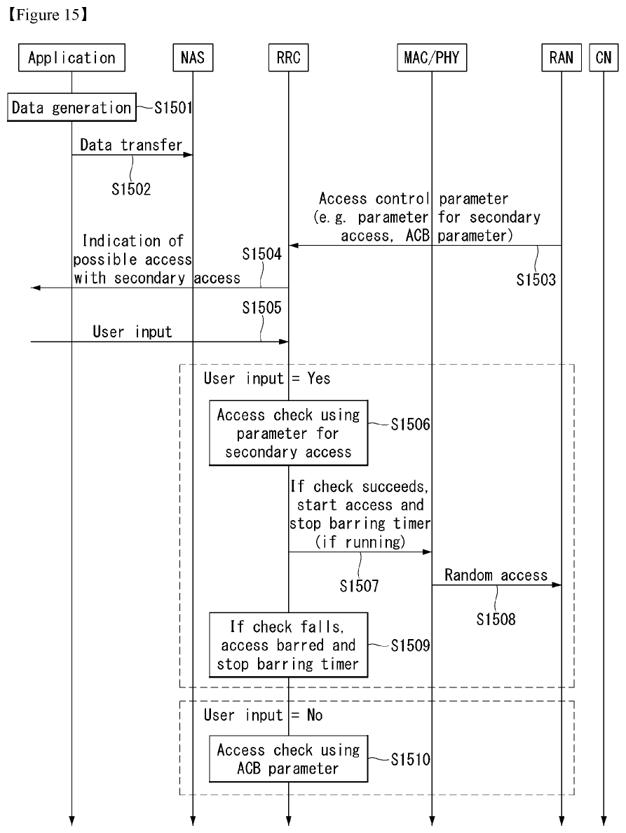

FIG. 15 illustrates a method of accessing a network according to an embodiment of the present invention.

Referring to FIG. 15, data to be transmitted to the network is generated in a specific application of the UE in S1501.

The data generated in the application of the UE is transferred to the NAS layer of the UE in S1502.

The UE (e.g., the RRC layer of the UE) receives a parameter related to the access control from the base station (i.e., RAN) in S1503.

In this instance, an access control parameter for UEs for which secondary access is possible and an existing access control parameter (i.e., first access control parameter, e.g., ACB parameter) for other UEs are transferred.

The UE recognizes that secondary access is possible for the UE itself, and informs/notifies the user whether access is performed to receive a selection from the user or that the UE can receive access services via the secondary access using NR/WIFI, etc. in S1504. In this instance, the UE may notify the user of it by displaying it on the screen as illustrated in FIG. 13 above, or may notify the user of it through alarm, vibration, etc., in case of a device not having a display.

Referring again to FIG. 12, if the UE receives an input from the user, user input information is transferred to the RRC layer of the UE in S1505.

Afterwards, the UE performs operation according to the input of the user identified in the previous step.

If the user input is “Yes” (i.e., attempting access via the secondary access), steps S1506 to S1509 are performed.

If the user wants a data access attempt via other RAT (i.e., secondary access), the UE checks whether access of the UE is allowed using an access control parameter related to the secondary access among information received in the step S1503 in S1507.

If access of the UE is allowed as a result of checking the step S1507, the UE starts a RRC connection establishment procedure via the secondary access in the corresponding cell in S1507. Further, if the UE is being executed, the UE stops an access barring timer.

To inform that access to the corresponding cell is access for secondary access, i.e., not the currently accessed RAT but other RAT such as NR or WIFI controlled in a current cell or RAN, for example, in a process of starting the RRC connection establishment procedure, the UE includes related information in a RRC connection request message or a message equivalent to the message.

In this instance, in the above process, a part of an access control related function may be performed even in the NAS layer instead of the RRC layer.

In conjunction with the step S1507, the MAC/PHY layer of the UE starts a random access procedure (so-called random access channel (RACH) procedure) to transmit real information in S1508.

When access of the UE is not allowed as a result of checking the step S1507, access of the UE is barred in S1509. Further, an access barring timer of the UE is stopped.

On the other hand, if the user input is “No” (i.e., not attempting access via the secondary access), the UE may recognize that the user wants not to use the secondary access such as NR/WIFI. Thus, step S1510 is performed.

If the user denies a data access attempt via other RAT, the UE performs an existing access control mechanism (i.e., access barring check using a first access control parameter (e.g., ACB parameter)) in the corresponding cell in S1510.

In FIGS. 12 to 15, a process of receiving an input of the user in relation to the access control may be performed each time. Further, the user may designate the process in advance through the configuration. In this case, a process of asking the user each time may be omitted.

In FIGS. 12 to 15, there may be various methods for actually implementing the access control parameter. For example, in 5GS, an access identity or an access category may be designated as one item, and specific conditions of a UE may be designated based on the item. For example, the specific conditions of the UE may include whether the UE supports the secondary RAT. Hence, the network may differently set an access control parameter used in the UE satisfying the specific conditions and an access control parameter used in other UE.

The embodiments according to the present invention have been mainly described and illustrated based on EPS, but may be similarly applied to 5GS (5G System).

Further, the embodiments according to the present invention have been described and illustrated based on the RRC connection establishment procedure, but may be applied to RRC connection resume or RRC message and procedure similar to the RRC connection resume in a similar method. In this case, in a similar method, an item related to an unlicensed band operation may be defined in an access category, or a category selecting or mapping the access category may be defined.

Various embodiments according to the present invention may be individually implemented, but one or more of the various embodiments may be combined.

Overview of Device to which the Present Invention is Applicable

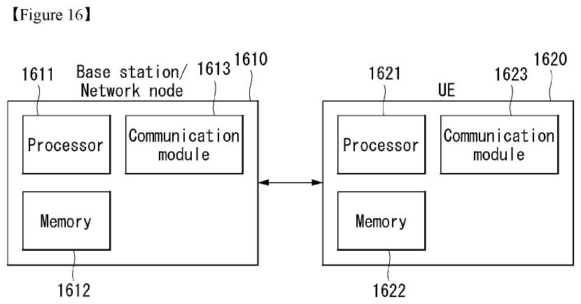

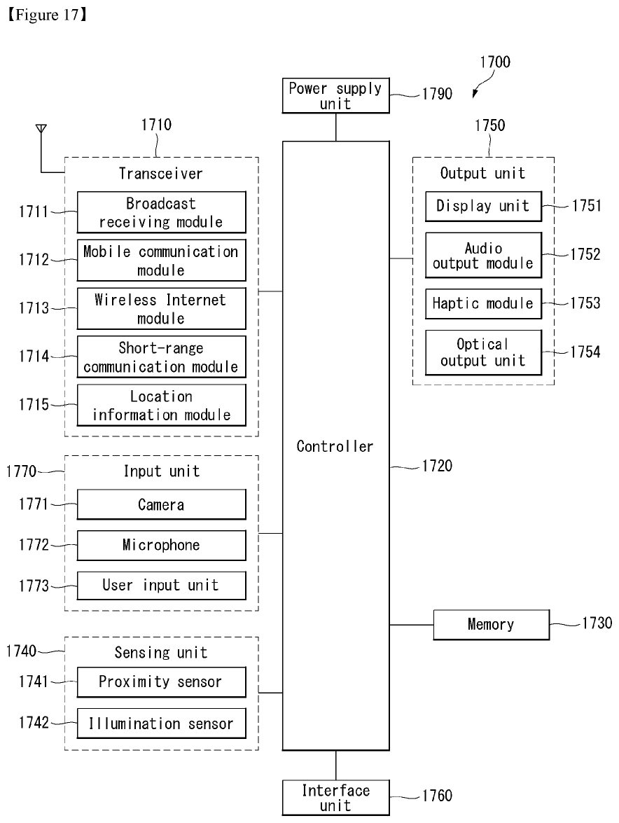

FIG. 16 illustrates a block configuration diagram of a communication device according to an embodiment of the present invention.

Referring to FIG. 16, a wireless communication system includes a network node 1610 and a plurality of UEs 1620.

The network node 1610 includes a processor 1611, a memory 1612, and a transceiver (or communication module) 1613. The processor 1611 implements functions, processes, and/or methods proposed in FIGS. 1 to 15. Layers of wired/wireless interface protocol may be implemented by the processor 1611.

The memory 1612 is connected to the processor 1611 and stores various types of information for driving the processor 1611. The transceiver 1613 is connected to the processor 1611 and transmits and/or receives wired/wireless signals. Examples of the network node 1610 may include a base station (eNB, ng-eNB and/or gNB), MME, AMF, SMF, HSS, SGW, PGW, SCEF, SCS/AS, and the like. In particular, when the network node 1610 is the base station (eNB, ng-eNB and/or gNB), the transceiver 1613 may include a radio frequency (RF) unit for transmitting/receiving a radio signal.

The UE 1620 includes a processor 1621, a memory 1622, and a transceiver (or RF unit, communication module) 1623. The processor 1621 implements functions, processes, and/or methods proposed in FIGS. 1 to 15. Layers of a radio interface protocol may be implemented by the processor 1621. In particular, the processor may include a NAS layer and an AS layer. The memory 1622 is connected to the processor 1621 and stores various types of information for driving the processor 1621. The transceiver 1623 is connected to the processor 1621 and transmits and/or receives a radio signal.

The memories 1612 and 1622 may be inside or outside the processors 1611 and 1621 and may be connected to the processors 1611 and 1621 through various well-known means. Further, the network node 1610 (in case of the base station) and/or the UE 1620 may have a single antenna or multiple antennas.

Mobile terminals disclosed herein may include cellular phones, smart phones, laptop computers, digital broadcast terminals, personal digital assistants (PDAs), portable multimedia players (PMPs), navigators, slate personal computers (PCs), tablet PCs, ultra books, wearable devices (e.g., smart watches, smart glasses, head mounted displays (HMDs)), and the like. Furthermore, the mobile terminals may be used for controlling at least one device in an Internet of Things (IoT) environment or a smart greenhouse.

However, except for the case that the configuration according to embodiments disclosed herein is applicable to only the mobile terminal, it can be readily apparent to those skilled in the art that embodiments may also be applied to stationary terminals such as digital TV, desktop computers, digital signage, and the like.

FIG. 17 is a block diagram illustrating a mobile terminal according to an embodiment of the present invention.

A mobile terminal 1700 may include a transceiver 1710, a processor (or control unit) 1720, a memory 1730, a sensing unit 1740, an output unit 1750, an interface unit 1760, an input unit 1770, and a power supply unit 1790, and the like. It is understood that implementing all of the components illustrated in FIG. 17 is not a requirement for the mobile terminal, and that more or fewer components may be alternatively implemented for the mobile terminal.

More specifically, the transceiver 1710 may include one or more modules which allow wireless communications between the mobile terminal 1700 and a wireless communication system, between the mobile terminal 1700 and another mobile terminal 1700, or between the mobile terminal 1700 and an external server. Further, the transceiver 1710 may include one or more modules which connect the mobile terminal 1700 to one or more networks.

The transceiver 1710 may include at least one of a broadcast receiving module 1711, a mobile communication module 1712, a wireless Internet module 1713, a short-range communication module 1714, and a location information module 1715.

The input unit 1770 may include a camera 1771 or a video input unit for inputting a video signal, a microphone 1772 or an audio input unit for inputting an audio signal, and a user input unit 1773 (e.g., a touch key, a push key, etc.) for allowing a user to input information. Audio data or image data obtained by the input unit 1770 may be analyzed and processed by user control commands.

The sensing unit 1740 may include one or more sensors for sensing at least one of internal information of the mobile terminal, information about a surrounding environment of the mobile terminal, and user information. For example, the sensing unit 1740 may include at least one of a proximity sensor 1741, an illumination sensor 1742, a touch sensor, an acceleration sensor, a magnetic sensor, a G-sensor, a gyroscope sensor, a motion sensor, an RGB sensor, an infrared (IR) sensor, a fingerprint scan sensor, a ultrasonic sensor, an optical sensor (e.g., the camera 1771), the microphone 1772, a battery gauge, an environment sensor (e.g., a barometer, a hygrometer, a thermometer, a radiation detection sensor, a thermal sensor, a gas sensor, etc.), and a chemical sensor (e.g., an electronic nose, a health care sensor, a biometric sensor, etc.). The mobile terminal disclosed herein may combine and utilize information sensed by at least two of the abovementioned sensors.

The output unit 1750 may be configured to output various types of information, such as audio, video, tactile output, and the like. The output unit 1750 may include at least one of a display unit 1751, an audio output module 1752, a haptic module 1753, and an optical output unit 1754. The display unit 1751 may form an inter-layered structure or an integrated structure with a touch sensor to implement a touch screen. The touch screen may function as the user input unit 1773 that provides an input interface between the mobile terminal 1700 and the user, and at the same time provide an output interface between the mobile terminal 1700 and the user.

The interface unit 1760 serves as an interface with various types of external devices connected to the mobile terminal 1700. The interface unit 1760 may include at least one of wired or wireless headset ports, external charger ports, wired or wireless data ports, memory card ports, ports for connecting a device having an identification module, audio input/output (I/O) ports, video I/O ports, and earphone ports. The mobile terminal 1700 may perform assorted control functions associated with a connected external device, in response to the external device being connected to the interface unit 1760.

The memory 1730 stores data to support various functions of the mobile terminal 1700. The memory 1730 may store multiple application programs or applications executed in the mobile terminal 1700, and data or instructions for operations of the mobile terminal 1700. At least a part of these application programs may be downloaded from an external server via wireless communication. At least apart of these application programs may be installed within the mobile terminal 1700 at time of manufacturing or shipping, which is the case for basic functions (e.g., receiving a call, placing a call, receiving a message, sending a message, etc.) of the mobile terminal 1700. It is common for application programs to be stored in the memory 1730, installed in the mobile terminal 1700, and executed by the processor 1720 to perform an operation (or function) of the mobile terminal 1700.

The processor 1720 typically functions to control overall operation of the mobile terminal 1700, in addition to the operations associated with the application programs. The processor 1720 may provide or process information or functions appropriate for a user by processing signals, data, information and the like which are input or output by the components described above, or running application programs stored in the memory 1730.

Further, the processor 1720 may control at least some of the components illustrated in FIG. 17 in order to run application programs that have been stored in the memory 1730. In addition, the processor 1720 may combine and operate at least two of the components included in the mobile terminal 1700 for the execution of the application programs.

The power supply unit 1790 receives external power and internal power and supplies the power to the respective components included in the mobile terminal 1700 under the control of the processor 1720. The power supply unit 1790 may include a battery, and the battery may be embedded in the terminal body or be detachable from the terminal body.

At least some of the above components may be combined with one another and operate, in order to implement an operation, a control, or a control method of a mobile terminal according to various embodiments described below. Further, an operation, a control, or a control method of a mobile terminal according to various embodiments may be implemented by running at least one application program stored in the memory 1730.

Before describing various embodiments implemented by the mobile terminal 1700 described above, the components depicted above will now be described in more detail with reference to FIG. 17.

Regarding the transceiver 1710, the broadcast receiving module 1711 of the transceiver 1710 receives broadcast signals and/or broadcast related information from an external broadcast management server via a broadcast channel. The broadcast channel may include a satellite channel, a terrestrial channel, etc. The two or more broadcast receiving modules 1711 may be provided to the mobile terminal 1700 for the simultaneous broadcast reception of at least two broadcast channels or the switching of broadcast channels.

The mobile communication module 1712 exchanges radio signals with at least one of a base station, an external terminal, and a server on a mobile communication network constructed according to technical standards or communication methods for mobile communications (e.g., Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), High Speed Uplink Packet Access (HSUPA), Long Term Evolution (LTE), LTE-A (Long Term Evolution-Advanced), 3GPP NR (New Radio access technology), and the like).

Examples of the radio signals may include audio call signals, video call signals, or various formats of data according to the exchange of text/multimedia messages.

The wireless Internet module 1713 is configured to facilitate wireless Internet access. The wireless Internet module 1713 may be embedded in the mobile terminal 1700 or externally coupled to the mobile terminal 1700. The wireless Internet module 1713 is configured to transmit and/or receive radio signals via communication networks according to wireless Internet technologies.

Examples of the wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-A (Long Term Evolution-Advanced), 3GPP NR, and the like. The wireless Internet module 1713 may transmit/receive data according to one or more of such wireless Internet technologies, and other Internet technologies as well.

From the viewpoint that the wireless Internet access according to WiBro, HSDPA, HSUPA, GSM, CDMA, WCDMA, LTE, LTE-A, 3GPP NR and the like, is implemented via a mobile communication network, the wireless Internet module performing the wireless Internet access via the mobile communication network may be understood as part of the mobile communication module.

The short-range communication module 1714 is configured to facilitate short-range communications and can support short-range communications using at least one of Bluetooth™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus) technologies. The short-range communication module 1714 can support wireless communications between the mobile terminal 1700 and a wireless communication system, between the mobile terminal 1700 and another mobile terminal 1700, or between the mobile terminal 1700 and a network where another mobile terminal 1700 (or an external server) is located, via wireless area networks. The wireless area networks may be wireless personal area networks.

Embodiments disclosed herein, another mobile terminal 1700 may be a wearable device (e.g., a smart watch, a smart glass, a neckband, or a head mounted display (HMD)) which is able to exchange data with the mobile terminal 1700 according to the present invention. The short-range communication module 1714 may sense (or recognize) the wearable device that is located around the mobile terminal 1700 and can communicate with the mobile terminal 1700. In addition, when the sensed wearable device is a device which is authenticated to communicate with the mobile terminal 1700 according to the present invention, the processor 1720 can transmit at least a part of data processed by the mobile terminal 1700 to the wearable device via the short-range communication module 1714. Thus, a user of the wearable device may use data processed by the mobile terminal 1700 through the wearable device. For example, when a call is received at the mobile terminal 1700, the user can answer the call using the wearable device. Also, when a message is received at the mobile terminal 1700, the user can check the received message using the wearable device.

Furthermore, screen mirroring with a TV located in the house or a display inside a car, etc. is implemented through the short-range communication module 1714, and the corresponding function is performed based on, for example, MirrorLink or Miracast standard or the like. Further, the user can directly control the TV or the display inside the car using the mobile terminal 1700.

The location information module 1715 is a module for obtaining a position (or a current position) of the mobile terminal. Representative examples of the location information module 1715 include a global position system (GPS) module or a wireless fidelity (Wi-Fi) module. For example, if the mobile terminal utilizes a GPS module, a position of the mobile terminal can be acquired using a signal sent from a GPS satellite. As another example, if the mobile terminal utilizes the Wi-Fi module, a position of the mobile terminal can be acquired based on information related to a wireless access point (AP) which transmits or receives a radio signal to or from the Wi-Fi module. If necessary or desired, the location information module 1715 may alternatively or additionally functions of the other modules of the transceiver 1710 to obtain data related to the position of the mobile terminal. The location information module 1715 is a module used to obtain a position (or current position) of the mobile terminal and is not limited to a module that directly calculates or obtains the position of the mobile terminal.

Each of the broadcast receiving module 1711, the mobile communication module 1712, the short-range communication module 1714, and the location information module 1715 may be implemented as a separate module performing the corresponding function. Alternatively, two or more of the broadcast receiving module 1711, the mobile communication module 1712, the short-range communication module 1714, and the location information module 1715 may be implemented as one module performing the corresponding functions.

The input unit 1770 is configured to input video information (or signal), audio information (or signal), data, or information input from the user. The mobile terminal 1700 may include one camera 1771 or a plurality of cameras 1771 to input video information. The camera 1771 processes image frames of still pictures or video obtained by an image sensor in a video call mode or a video recording mode. The processed image frames may be displayed on the display unit 1751 or stored in the memory 1730. The plurality of cameras 1771 included in the mobile terminal 1700 may be arranged to form a matrix structure, and various video information with various angles or focal points may be input to the mobile terminal 1700 through the cameras 1771 forming the matrix structure. Alternatively, the plurality of cameras 1771 may be disposed in a stereoscopic structure to obtain left and right images for implementing a stereoscopic image.

The microphone 1772 processes external audio signals into electrical voice data. The processed voice data can be variously utilized according to a function that is performing by the mobile terminal 1700 (or an application program that is running on the mobile terminal 1700). The microphone 1772 can implement various noise removing algorithms for removing a noise generated in a process for receiving the external audio signals.

The user input unit 1773 is a component that allows information input by a user. If information is input via the user input unit 1773, the processor 7120 can control an operation of the mobile terminal 1700 in conformity with the input information. The user input unit 1773 may include mechanical input means (or a mechanical key, for example, a button located on a front or rear surface or a side of the mobile terminal 1700, a dome switch, a jog wheel, a jog switch, etc.) and touch input means. As one example, the touch input means may include a virtual key, a soft key, or a visual key which is displayed on a touch screen through software processing, or a touch key which is disposed on other portions of the mobile terminal except the touch screen. The virtual key or the visual key can be displayed on the touch screen in various shapes, for example, graphic, text, icon, video, or a combination thereof.

The sensing unit 1740 senses at least one of internal information of the mobile terminal, surrounding environment information of the mobile terminal, and user information and generates a sensing signal corresponding to the sensed information. The processor 1720 may control a drive or an operation of the mobile terminal 1700 based on the sensing signal, or perform data processing, a function or an operation related to an application program installed in the mobile terminal 1700 based on the sensing signal. The sensing unit 1740 may be implemented using some various sensors, some of which will now be described in more detail.

The proximity sensor 1741 refers to a sensor that senses presence or absence of an object approaching a predetermined detection surface or an object located around the predetermined detection surface, by using an electromagnetic force, infrared rays, or the like without a mechanical contact. The proximity sensor 1741 may be disposed in an inner region of the mobile terminal covered by the touch screen described above or disposed around the touch screen.

Examples of the proximity sensor 1741 include a transmissive photoelectric sensor, a direct reflective photoelectric sensor, a mirror reflective photoelectric sensor, a high-frequency oscillation proximity sensor, a capacitive proximity sensor, a magnetic proximity sensor, an infrared proximity sensor, and the like. When the touch screen is implemented as a capacitive touch sensor, the proximity sensor 1741 may be configured to sense proximity of an object with conductivity using changes in an electromagnetic field which is responsive to an approach of the object with conductivity. In this instance, the touch screen (or the touch sensor) itself may be categorized as a proximity sensor.

For convenience of explanation, the term “proximity touch” refers to a scenario in which an object is proximate to the touch screen without contacting the touch screen and is recognized to be positioned on the touch screen, and the term “contact touch” refers to a scenario in which an object actually contacts the touch screen. A position corresponding to the proximity touch of the object relative to the touch screen corresponds to a position where the object is perpendicular to the touch screen upon the proximity touch of the object. The proximity sensor 1741 can sense proximity touch and proximity touch patterns (e.g., a proximity touch distance, a proximity touch direction, a proximity touch speed, a proximity touch time, a proximity touch position, a proximity touch moving status, etc.). The processor 1720 can process data (or information) corresponding to proximity touch operations and proximity touch patterns sensed by the proximity sensor 1741, and also output visual information corresponding to the processed data on the touch screen. In addition, the processor 1720 can control the mobile terminal 1700 so that different operations or data (or information) are processed according to whether a touch of the same portion on the touch screen is either a proximity touch or a contact touch.

A touch sensor senses a touch (or a touch input) applied to the touch screen (or the display unit 1751) using at least one of various touch methods including a resistive type, a capacitive type, an infrared type, an ultrasonic type, a magnetic field type, and the like.

As one example, the touch sensor may be configured to convert changes in a pressure applied to a specific part of the touch screen or changes in a capacitance occurring in a specific part of the touch screen into electrical input signals. The touch sensor may also be configured so that a touch object applying a touch input to the touch screen can sense a touched position or a touched area on the touch sensor, a touch pressure, a touch capacitance, or the like. In embodiments disclosed herein, the touch object is generally used to apply a touch input to the touch sensor. Examples of the touch object may include a finger, a touch pen, a stylus pen, a pointer, or the like.

When there is a touch input with respect to the touch sensor as described above, signal(s) corresponding to the touch input may be transmitted to a touch controller. The touch controller may process the received signal(s) and then transmit corresponding data to the processor 1720. Thus, the processor 1720 may sense which region of the display unit 1751 has been touched. In embodiments disclosed herein, the touch controller may be configured separately from the processor 1720, or may be the processor 1720 itself.

The processor 1720 may execute the same control or different controls in accordance with a kind of a touch object that touches the touch screen (or a touch key provided in addition to the touch screen). Whether to perform the same control or different controls in accordance with the kind of the touch object may be determined based on a current operating state of the mobile terminal 1700 or an application program that is running.

The touch sensor and the proximity sensor described above may be individually implemented or combined to sense various types of touches with respect to the touch screen including a short (or tap) touch, a long touch, a multi-touch, a drag touch, a flick touch, a pinch-in touch, a pinch-out touch, a swipe touch, a hovering touch, and the like.

The ultrasonic sensor may recognize location information of a touch object using ultrasonic waves. The processor 1720 can calculate a location of a wave generation source based on information sensed by an optical sensor and a plurality of ultrasonic sensors. The location of the wave generation source can be calculated using the fact that light is much faster than ultrasonic waves, namely, the time it takes for the light to reach the optical sensor is much shorter than the time it takes for the ultrasonic wave to reach the ultrasonic sensor. More specifically, the location of the wave generation source can be calculated using a difference in the reaching time described above between the light and the ultrasonic wave.

In the configuration of the input unit 1770, the camera 1771 includes at least one of a camera sensor (e.g., CCD, CMOS etc.), a photo sensor (or image sensors), and a laser sensor.

The camera 1771 and a laser sensor may be combined and may sense a touch of a sensing object with respect to a 3D stereoscopic image. The photo sensor may be stacked on the display device. The photo sensor may be configured to scan a movement of the sensing object in proximity to the touch screen. More specifically, the photo sensor may mount photo diodes and transistors on rows/columns and scan contents mounted on the photo sensor using an electrical signal that changes depending on an amount of light applied to the photo diodes. That is, the photo sensor can calculate coordinates of the sensing object depending on a variation of light and obtain location information of the sensing object through the coordinates.

The display unit 1751 displays (or outputs) information processed by the mobile terminal 1700. For example, the display unit 1751 may display execution screen information of an application program running on the mobile terminal 1700 or display user interface (UI) information and graphic user interface (GUI) information in response to the execution screen information.

Further, the display unit 1751 may be implemented as a stereoscopic display unit for displaying a stereoscopic image.

The stereoscopic display unit may employ a 3D display scheme such as a stereoscopic scheme (a glass scheme), an auto-stereoscopic scheme (glassless scheme), a projection scheme (holographic scheme), or the like.

The audio output module 1752 may output audio data, that is received from the transceiver 1710 or is stored in the memory 1730, in a call signal reception mode, a call mode or a record mode, a voice recognition mode, a broadcast reception mode, and the like. The audio output module 1752 may output an audio signal related to a function (e.g., a call signal reception sound, a message reception sound, etc.) performed by the mobile terminal 1700. The audio output module 1752 may also include a receiver, a speaker, a buzzer, or the like.

The haptic module 1753 generates various tactile effects that the user can feel. A typical example of the tactile effect generated by the haptic module 1753 may be a vibration. A strength, a pattern, etc. of the vibration generated by the haptic module 153 can be controlled by the selection of the user or setting of the processor. For example, the haptic module 1753 may output different vibrations in a combination manner or a sequential manner.

In addition to the vibration, the haptic module 1753 may generate various tactile effects including an effect by stimulation such as a pin arrangement moving vertically to a contact skin, a spray force or a suction force of air through a jet orifice or a suction opening, a touch of the skin, a contact of an electrode, and an electrostatic force, an effect by reproducing the sense of cold and warmth using an element that can absorb or generate heat, and the like.

The haptic module 1753 may also be implemented to allow the user to feel a tactile effect through a muscle sensation such as the user's fingers or arm, as well as transferring the tactile effect through the direct contact. Two or more haptic modules 1753 may be provided according to the particular configuration of the mobile terminal 1700.

The optical output unit 1754 outputs a signal for indicating an event generation using light of a light source of the mobile terminal 1700. Examples of events generated in the mobile terminal 1700 may include message reception, call signal reception, a missed call, an alarm, a schedule notice, an email reception, information reception through an application, and the like.

A signal output by the optical output unit 1754 is implemented in such a manner that the mobile terminal 1700 emits light or light with single color or a plurality of colors to a front surface or a rear surface. The signal output may be terminated as the mobile terminal senses that the user has checked the generated event.

The interface unit 1760 serves as an interface for all of external devices connected to the mobile terminal 1700. The interface unit 1760 is configured to receive data from the external device, receive power to transfer the power to the respective components of the mobile terminal 1700, or transmit internal data of the mobile terminal 1700 to the external device. For example, the interface unit 1760 may include wired or wireless headset ports, external charger ports, wired or wireless data ports, memory card ports, ports for connecting a device with an identification module, audio input/output (I/O) ports, video I/O ports, earphone ports, or the like.

The identification module may be a chip that stores various types of information for authenticating usage authority of the mobile terminal 1700 and may include a user identity module (UIM), a subscriber identity module (SIM), a universal subscriber identity module (USIM), and the like. In addition, the device with the identification module (hereinafter referred to as “identification device”) may be manufactured as a smart card. Thus, the identification device may be connected to the mobile terminal 1700 via the interface unit 1760.

When the mobile terminal 1700 is connected to an external cradle, the interface unit 1760 may serve as a passage to allow power from the cradle to be supplied to the mobile terminal 1700 or a passage to allow various command signals input by the user from the cradle to be transferred to the mobile terminal. The various command signals or the power input from the cradle may operate as signals for recognizing that the mobile terminal 1700 is properly mounted on the cradle.

The memory 1730 may store programs for operations of the processor 1720 and temporarily store input/output data (e.g., phonebook, messages, still images, videos, etc.). The memory 1730 may store data about various patterns of vibration and audio which are output in response to a touch input on the touch screen.

The memory 1730 may include at least one type of storage medium of a flash memory, a hard disk, a solid state disk (SSD), a silicon disk drive (SDD), a multimedia card micro type, a card type memory (e.g., SD or DX memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The mobile terminal 1700 may also be operated in relation to a web storage that performs a storage function of the memory 1730 over Internet.

As described above, the processor 1720 typically controls operations related to application programs and the overall operations of the mobile terminal 1700. For example, if a state of the mobile terminal satisfies determined conditions, the processor 1720 may execute or release a lock state for restricting an input of user's control command with respect to applications.

The processor 1720 can perform control and processing related to voice call, data communication, video call, and the like, or perform pattern recognition processing capable of recognizing a handwriting input or a picture drawing input performed on the touch screen as characters or images, respectively. In addition, the processor 1720 can control one or a combination of the abovementioned components in order to implement various embodiments disclosed herein.

The power supply unit 1790 receives external power and internal power and supplies power necessary for operation of the respective components included in the mobile terminal 1700 under the control of the processor 1720. The power supply unit 1790 may include a battery, and the battery may be an embedded rechargeable battery or be detachable from the terminal body for charging.

The power supply unit 1790 may include a connection port. The connection port may be configured as an example of the interface unit 1760 to which an external charger for supplying power to charge the battery is electrically connected.

As another example, the power supply unit 1790 may be configured to charge the battery in a wireless manner without using the connection port. In this case, the power supply unit 1790 can receive power from an external wireless power transmitter using one or more of an inductive coupling method based on a magnetic induction phenomenon or a magnetic resonance coupling method based on an electromagnetic resonance phenomenon.

Various embodiments described herein may be implemented in a recording medium readable by a computer or devices similar to the computer.

The mobile terminal may be expanded to a wearable device the user can directly wear beyond a hand-held device, which the user carries and uses in his or her hand. Examples of the wearable device include a smart watch, a smart glass, and a head mounted display (HMD). Examples of the mobile terminal expanded to the wearable device will now be described in more detail.

The wearable device may be configured to exchange (or interwork) data with another mobile terminal 1700. The short-range communication module 1714 may sense (or recognize) the wearable device, which is positioned around the mobile terminal 1700 and can communicate with the mobile terminal 1700. Furthermore, when the sensed wearable device is a device which is authenticated to communicate with the mobile terminal 1700, the processor 1720 may transmit at least a portion of data processed in the mobile terminal 1700 to the wearable device via the short-range communication module 1714. Thus, the user of the wearable device may use the data processed in the mobile terminal 1700 on the wearable device. For example, when a call is received at the mobile terminal 1700, the user can answer the call using the wearable device. Also, when a message is received at the mobile terminal 1700, the user can check the received message using the wearable device.

Hereinafter, embodiments related to a control method which can be implemented by the mobile terminal configured as above are described with reference to the accompanying drawings. It is apparent to those skilled in the art that various modifications can be made to within the range without departing from the spirit and essential features of the present invention.

The embodiments described above are implemented by combinations of components and features of the present invention in predetermined forms. Each component or feature should be considered selectively unless specified separately. Each component or feature may be carried out without being combined with another component or feature. Moreover, some components and/or features are combined with each other and can implement embodiments of the present invention. The order of operations described in embodiments of the present invention may be changed. Some components or features of one embodiment may be included in another embodiment, or may be replaced by corresponding components or features of another embodiment. It will be apparent that some claims referring to specific claims may be combined with another claims referring to the claims other than the specific claims to constitute the embodiment or add new claims by means of amendment after the application is filed.

Embodiments of the present invention can be implemented by various means, for example, hardware, firmware, software, or combinations thereof. When embodiments are implemented by hardware, an embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, an embodiment of the present invention can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present invention can be embodied in other specific forms without departing from essential features of the present invention. Accordingly, the aforementioned detailed description should not be construed as limiting in all aspects and should be considered as illustrative. The scope of the present invention should be determined by rational construing of the appended claims, and all modifications within an equivalent scope of the present invention are included in the scope of the present invention.

### INDUSTRIAL APPLICABILITY

Although the present invention has been described focusing on examples applying to the 3GPP LTE/LTE-A system, it can be applied to various wireless communication systems, particularly, the 5G system other than the 3GPP LTE/LTE-A system.

1. A method of accessing, by a user equipment (UE), a network in a wireless communication system, the method comprising:
receiving, from a base station, information that a service access from the network via a second radio access technology (RAT) is possible on a cell camping on via a first RAT;
informing a user that the service access via the second RAT is possible; and
performing an access to the network so that a service is provided from the network via the second RAT on the cell when the service access via the second RAT is selected from the user.

2. The method of claim 1, wherein information that an access barring check operation is able to be skipped is further received upon an attempt to access the network so that the service is provided from the network via the second RAT on the cell.

3. The method of claim 2, wherein the access barring check operation is not performed upon an attempt to access the network so that the service is provided from the network via the second RAT on the cell.

4. The method of claim 1, further comprising waiting until an access barring timer expires if the service access via the second RAT is not selected from the user.

5. The method of claim 1, further comprising:
receiving an access control parameter for the first RAT on the cell; and
performing an access barring operation using the access control parameter for the first RAT.

6. The method of claim 5, wherein when an access via the first RAT is barred on the cell based on the access barring operation using the access control parameter for the first RAT, the information is received.

7. The method of claim 1, wherein an access control parameter for the second RAT is further received on the cell.

8. The method of claim 7, wherein the performing of the access to the network comprises:
performing an access barring operation using the access control parameter for the second RAT when the service access via the second RAT is selected from the user; and
performing an access to the network via the second RAT when the access via the second RAT is not barred on the cell based on the access barring operation.

9. The method of claim 1, further comprising configuring whether to allow the access to the network via the second RAT for each application based on an input from the user.

10. A user equipment (UE) performing an access to a network in a wireless communication system, the UE comprising:
a transceiver configured to transmit and receive a radio signal;
an input unit;
an output unit; and
a processor configured to control the transceiver and the output unit,
wherein the processor is configured to:
receive, from a base station, information that a service access from the network via a second radio access technology (RAT) is possible on a cell camping on via a first RAT;
inform a user that the service access via the second RAT is possible, through the output unit; and
perform an access to the network so that a service is provided from the network via the second RAT on the cell when the service access via the second RAT is selected from the user through the input unit.
